(19) United States
(12) Patent Application Publication
(10) Pub. No.: US 2022/0107517 A1
(43) Pub. Date: Apr. 7, 2022

(54) OFF-AXIS FOCUSING GEOMETRIC PHASE LENS AND SYSTEM INCLUDING THE SAME

(71) Applicant: Facebook Technologies, LLC, Menlo Park, CA (US)

(72) Inventors: Oleg YAROSHCHUK, Redmond, WA (US); Wai Sze Tiffany LAM, Bothell, WA (US); Yun-Han LEE, Redmond, WA (US); Maxwell PARSONS, Seattle, WA (US); Andrew John OUDERKIRK, Kirkland, WA (US); Lu LU, Kirkland, WA (US); Scott Charles MCELDOWNEY, Redmond, WA (US)

(21) Appl. No.: 17/063,710

(22) Filed: Oct. 5, 2020

(51) Int. Cl. G02F 1/01; G02B 27/01; G02F 1/137

(52) U.S. Cl. CPC G02F 1/0136; G02B 27/0172; G02F 2203/50; G02F 2203/62; G02B 2027/0178; G02F 1/137

(57) ABSTRACT

A lens is provided. The lens includes an optically anisotropic film. The optically anisotropic film has an optic axis configured with an in-plane rotation in at least two opposite in-plane directions from a lens pattern center to opposite lens peripheries. The optic axis rotates in a same rotation direction from the lens pattern center to the opposite lens peripheries. An azimuthal angle changing rate of the optic axis is configured to increase from the lens pattern center to the opposite lens peripheries in at least a portion of the lens including the lens pattern center. The lens pattern center is shifted from a geometry center of the lens by a predetermined distance in a predetermined direction.

### TECHNICAL FIELD

The present disclosure generally relates to optical devices and systems and, more specifically, to an off-axis focusing geometric phase lens and a system including the same.

### BACKGROUND

In a conventional optical system, in order to correct off-axis aberration, conventional lenses may be tilted at relatively large angles. The tilting configuration of the conventional lenses may increase the size of the optical system. Diffractive off-axis focusing lenses can provide off-axis focusing without tilting, or with tilting at smaller angles as compared with the conventional lenses. Thus, diffractive off-axis focusing lenses may reduce a forma factor of the optical system. Moreover, diffractive off-axis focusing lenses may perform two or more functions simultaneously, such as deflection, focusing, spectral and polarization selection of light. Geometric phase (“GP”) lenses (also referred to as Pancharatnam-Berry phase (“PBP”) lenses) may be formed in an optically anisotropic material layer with an intrinsic or induced (e.g., photo-induced) optical anisotropy. The optically anisotropic material may be liquid crystals, liquid crystal polymers, or metasurfaces. In the optically anisotropic material, a desirable lens phase profile may be directly encoded into a local orientation of an optic axis of the optically anisotropic material layer. GP or PBP lenses modulate a circularly polarized light based on a lens phase profile provided through the geometric phase. PBP lenses may be flat or curved diffractive lenses sensitive to handedness of a circularly polarized incident light or an elliptically polarized incident light. PBP lenses may be switchable between a focusing state and a defocusing state by reversing the handedness of a circularly polarized incident light.

### SUMMARY OF THE DISCLOSURE

One aspect of the present disclosure provides a lens. The lens includes an optically anisotropic film. The optically anisotropic film has an optic axis configured with an in-plane rotation in at least two opposite in-plane directions from a lens pattern center to opposite lens peripheries. The optic axis rotates in a same rotation direction from the lens pattern center to the opposite lens peripheries. An azimuthal angle changing rate of the optic axis is configured to increase from the lens pattern center to the opposite lens peripheries in at least a portion of the lens including the lens pattern center. The lens pattern center is shifted from a geometry center of the lens by a predetermined distance in a predetermined direction.

Another aspect of the present disclosure provides a system. The system includes an optical combiner. The system also includes a display assembly. The display assembly includes a light source configured to emit a light. The lens includes an optically anisotropic film. The optically anisotropic film has an optic axis configured with an in-plane rotation in at least two opposite in-plane directions from a lens pattern center to opposite lens peripheries. The optic axis rotates in a same rotation direction from the lens pattern center to the opposite lens peripheries. An azimuthal angle changing rate of the optic axis is configured to increase from the lens pattern center to the opposite lens peripheries in at least a portion of the lens including the lens pattern center. The lens pattern center is shifted from a geometry center of the lens by a predetermined distance in a predetermined direction. The display assembly also includes a beam steering device configured to steer the light received from the lens toward the optical combiner. The optical combiner is configured to direct the light received from the beam steering device to an eye-box of the system.

Another aspect of the present disclosure provides a system. The system includes a light source configured to emit a light. The system also includes a lens configured to deflect the light to illuminate an object. The lens includes an optically anisotropic film. The optically anisotropic film has an optic axis configured with an in-plane rotation in at least two opposite in-plane directions from a lens pattern center to opposite lens peripheries. The optic axis rotates in a same rotation direction from the lens pattern center to the opposite lens peripheries. An azimuthal angle changing rate of the optic axis is configured to increase from the lens pattern center to the opposite lens peripheries in at least a portion of the lens including the lens pattern center. The lens pattern center is shifted from a geometry center of the lens by a predetermined distance in a predetermined direction. The system also includes a redirecting element configured to redirect the light reflected by the object. The system further includes an optical sensor configured to generate an image of the object based the redirected light received from the redirecting element.

Other aspects of the present disclosure can be understood by those skilled in the art in light of the description, the claims, and the drawings of the present disclosure.

### BRIEF DESCRIPTION OF THE DRAWINGS

The accompanying drawings are provided for illustrative purposes according to various disclosed embodiments and are not intended to limit the scope of the present disclosure. In the drawings:

FIG. 1A illustrates a schematic diagram of an off-axis focusing Geometric Phase (“GP”) lens or Pancharatnam-Berry phase (“PBP”) lens, according to an embodiment of the present disclosure;

FIG. 1B illustrates a schematic diagram of an off-axis focusing PBP lens, according to another embodiment of the present disclosure;

FIG. 1C illustrates a schematic diagram of an off-axis focusing PBP lens, according to another embodiment of the present disclosure;

FIG. 1D illustrates a schematic diagram of an off-axis focusing PBP lens, according to another embodiment of the present disclosure;

FIG. 2A illustrates a liquid crystal (“LC”) alignment pattern in an on-axis focusing PBP lens, according to an embodiment of the present disclosure;

FIG. 2B illustrates a section of an LC alignment pattern taken along an x-axis in the on-axis focusing PBP lens shown in FIG. 2A, according to an embodiment of the present disclosure;

FIG. 2C illustrates an LC alignment pattern in an on-axis focusing PBP lens, according to another embodiment of the present disclosure;

FIG. 2D illustrates a side view of the on-axis focusing PBP lens shown in FIG. 2A or FIG. 2C, according to an embodiment of the present disclosure;

FIG. 3A illustrates an LC alignment pattern in an off-axis focusing PBP lens, according to an embodiment of the present disclosure;

FIG. 3B illustrates a section of an LC alignment pattern along an x-axis in the off-axis focusing PBP lens shown in FIG. 3A, according to an embodiment of the present disclosure;

FIG. 3C illustrates an LC alignment pattern in an off-axis focusing PBP lens, according to another embodiment of the present disclosure;

FIG. 3D illustrates a side view of the off-axis focusing PBP lens shown in FIG. 3A or FIG. 3C, according to an embodiment of the present disclosure;

FIGS. 4A-4F illustrate deflection of lights by an off-axis focusing PBP lens, according to an embodiment of the present disclosure;

FIGS. 5A and 5B illustrate a switching of an off-axis focusing PBP lens between a focusing state and a defocusing state, according to an embodiment of the present disclosure;

FIGS. 6A and 6B illustrate a switching of an active off-axis focusing PBP lens between a focusing state and a neutral state, according to an embodiment of the present disclosure;

FIGS. 7A and 7B illustrate a switching of an active off-axis focusing PBP lens between a focusing state and a neutral state, according to another embodiment of the present disclosure;

FIG. 8 illustrates a schematic diagram of a lens stack including one or more off-axis focusing PBP lenses, according to an embodiment of the present disclosure;

FIG. 9 illustrates a schematic diagram of a near-eye display (“NED”), according to an embodiment of the present disclosure;

FIG. 10 illustrates a cross-sectional view of half of the NED shown in FIG. 9, according to another embodiment of the present disclosure;

FIG. 11A illustrates a schematic diagram of an eye illumination arrangement in an object-tracking system, according to an embodiment of the present disclosure;

FIG. 11B illustrates a light intensity distribution provided by the object-tracking system shown in FIG. 11A at an object, according to an embodiment of the present disclosure;

FIG. 12A illustrates a schematic diagram of an eye illumination arrangement in an conventional eye-tracking system;

FIG. 12B illustrates a light intensity distribution provided by the conventional eye-tracking system shown in FIG. 12A at an eye of a user;

FIG. 13 illustrates a schematic diagram of an object-tracking system, according to another embodiment of the present disclosure;

FIG. 14A illustrates a varying periodicity of an off-axis focusing PBP lens, according to an embodiment of the present disclosure; and

FIG. 14B illustrates a varying periodicity of an off-axis focusing PBP lens, according to another embodiment of the present disclosure.

### DETAILED DESCRIPTION

Embodiments consistent with the present disclosure will be described with reference to the accompanying drawings, which are merely examples for illustrative purposes and are not intended to limit the scope of the present disclosure. Wherever possible, the same reference numbers are used throughout the drawings to refer to the same or similar parts, and a detailed description thereof may be omitted.

Further, in the present disclosure, the disclosed embodiments and the features of the disclosed embodiments may be combined. The described embodiments are some but not all of the embodiments of the present disclosure. Based on the disclosed embodiments, persons of ordinary skill in the art may derive other embodiments consistent with the present disclosure. For example, modifications, adaptations, substitutions, additions, or other variations may be made based on the disclosed embodiments. Such variations of the disclosed embodiments are still within the scope of the present disclosure. Accordingly, the present disclosure is not limited to the disclosed embodiments. Instead, the scope of the present disclosure is defined by the appended claims.

As used herein, the terms “couple,” “coupled,” “coupling,” or the like may encompass an optical coupling, a mechanical coupling, an electrical coupling, an electromagnetic coupling, or a combination thereof. An “optical coupling” between two optical elements refers to a configuration in which the two optical elements are arranged in an optical series, and a light output from one optical element may be directly or indirectly received by the other optical element. An optical series refers to optical positioning of a plurality of optical elements in a light path, such that a light output from one optical element may be transmitted, reflected, diffracted, converted, modified, or otherwise processed or manipulated by one or more of other optical elements. In some embodiments, the sequence in which the plurality of optical elements are arranged may or may not affect an overall output of the plurality of optical elements. A coupling may be a direct coupling or an indirect coupling (e.g., coupling through an intermediate element).

The phrase “at least one of A or B” may encompass all combinations of A and B, such as A only, B only, or A and B. Likewise, the phrase “at least one of A, B, or C” may encompass all combinations of A, B, and C, such as A only, B only, C only, A and B, A and C, B and C, or A and B and C. The phrase “A and/or B” may be interpreted in a manner similar to that of the phrase “at least one of A or B.” For example, the phrase “A and/or B” may encompass all combinations of A and B, such as A only, B only, or A and B. Likewise, the phrase “A, B, and/or C” has a meaning similar to that of the phrase “at least one of A, B, or C.” For example, the phrase “A, B, and/or C” may encompass all combinations of A, B, and C, such as A only, B only, C only, A and B, A and C, B and C, or A and B and C.

When a first element is described as “attached,” “provided,” “formed,” “affixed,” “mounted,” “secured,” “connected,” “bonded,” “recorded,” or “disposed,” to, on, at, or at least partially in a second element, the first element may be “attached,” “provided,” “formed,” “affixed,” “mounted,” “secured,” “connected,” “bonded,” “recorded,” or “disposed,” to, on, at, or at least partially in the second element using any suitable mechanical or non-mechanical manner, such as depositing, coating, etching, bonding, gluing, screwing, press-fitting, snap-fitting, clamping, etc. In addition, the first element may be in direct contact with the second element, or there may be an intermediate element between the first element and the second element. The first element may be disposed at any suitable side of the second element, such as left, right, front, back, top, or bottom.

When the first element is shown or described as being disposed or arranged “on” the second element, term “on” is merely used to indicate an example relative orientation between the first element and the second element. The description may be based on a reference coordinate system shown in a figure, or may be based on a current view or example configuration shown in a figure. For example, when a view shown in a figure is described, the first element may be described as being disposed “on” the second element. It is understood that the term “on” may not necessarily imply that the first element is over the second element in the vertical, gravitational direction. For example, when the assembly of the first element and the second element is turned 180 degrees, the first element may be “under” the second element (or the second element may be “on” the first element). Thus, it is understood that when a figure shows that the first element is “on” the second element, the configuration is merely an illustrative example. The first element may be disposed or arranged at any suitable orientation relative to the second element (e.g., over or above the second element, below or under the second element, left to the second element, right to the second element, behind the second element, in front of the second element, etc.).

The term “communicatively coupled” or “communicatively connected” indicates that related items are coupled or connected through an electrical and/or electromagnetic coupling or connection, such as a wired or wireless communication connection, channel, or network.

The wavelength ranges, spectra, or bands mentioned in the present disclosure are for illustrative purposes. The disclosed optical device, system, element, assembly, and method may be applied to a visible wavelength range, as well as other wavelength ranges, such as an ultraviolet (“UV”) wavelength range, an infrared wavelength range, or a combination thereof.

The term “processor” used herein may encompass any suitable processor, such as a central processing unit (“CPU”), a graphics processing unit (“GPU”), an application-specific integrated circuit (“ASIC”), a programmable logic device (“PLD”), or a combination thereof. Other processors not listed above may also be used. A processor may be implemented as software, hardware, firmware, or a combination thereof.

The term “controller” may encompass any suitable electrical circuit, software, or processor configured to generate a control signal for controlling a device, a circuit, an optical element, etc. A “controller” may be implemented as software, hardware, firmware, or a combination thereof. For example, a controller may include a processor, or may be included as a part of a processor.

The term “object-tracking system,” “object-tracking device,” “eye-tracking system,” or “eye-tracking device” may include suitable elements configured to obtain eye-tracking information, or to obtain sensor data for determining eye-tracking information. For example, the object-tracking (e.g., eye-tracking) system or device may include one or more suitable sensors (e.g., an optical sensor, such as a camera, motion sensors, etc.) to capture sensor data (e.g., images) of a tracked object (e.g., an eye of a user). In some embodiments, the object-tracking (e.g., eye-tracking) system or device may include a light source configured to emit a light to illuminate the tracked object (e.g., the eye of the user). The object-tracking (e.g., eye-tracking) system or device may also include a processor or controller configured to process the sensor data (e.g., the images) of the tracked object (e.g., the eye of the user) to obtain object-tracking information (e.g., eye-tracking information). The processor or controller may provide the object-tracking (e.g., eye-tracking) information to another device, or may process the object-tracking (e.g., eye-tracking) information to control another device, such as a grating, a lens, a waveplate, etc. The object-tracking (e.g., eye-tracking) system or device may also include a non-transitory computer-readable medium, such as a memory, configured to store computer-executable instructions, and sensor data or information, such as the captured image and/or the object-tracking (e.g., eye-tracking) information obtained from processing the captured image. In some embodiments, the object-tracking (e.g., eye-tracking) system or device may transmit the sensor data to another processor or controller (e.g., a processor of another device, such as a cloud-based device) for determining the object-tracking (e.g., eye-tracking) information.

The term “non-transitory computer-readable medium” may encompass any suitable medium for storing, transferring, communicating, broadcasting, or transmitting data, signal, or information. For example, the non-transitory computer-readable medium may include a memory, a hard disk, a magnetic disk, an optical disk, a tape, etc. The memory may include a read-only memory (“ROM”), a random-access memory (“RAM”), a flash memory, etc.

As used herein, the term “liquid crystal compound” or “mesogenic compound” may refer to a compound including one or more calamitic (rod- or board/lath-shaped) or discotic (disk-shaped) mesogenic groups. The term “mesogenic group” may refer to a group with the ability to induce liquid crystalline phase (or mesophase) behavior. In some embodiments, the compounds including mesogenic groups may not exhibit a liquid crystal (“LC”) phase themselves. Instead, the compounds may exhibit the LC phase when mixed with other compounds. In some embodiments, the compounds may exhibit the LC phase when the compounds, or the mixture containing the compounds, are polymerized. For simplicity of discussion, the term “liquid crystal” is used hereinafter for both mesogenic and LC materials. In some embodiments, a calamitic mesogenic group may include a mesogenic core including one or more aromatic or non-aromatic cyclic groups connected to each other directly or via linkage groups. In some embodiments, a calamitic mesogenic group may include terminal groups attached to the ends of the mesogenic core. In some embodiments, a calamitic mesogenic group may include one or more lateral groups attached to a long side of the mesogenic core. These terminal and lateral groups may be selected from, e.g., carbyl or hydrocarbyl groups, polar groups such as halogen, nitro, hydroxy, etc., or polymerizable groups.

As used herein, the term “reactive mesogen” (“RM”) may refer to a polymerizable mesogenic or a liquid crystal compound. A polymerizable compound with one polymerizable group may be also referred to as a “mono-reactive” compound. A compound with two polymerizable groups may be referred to as a “di-reactive” compound, and a compound with more than two polymerizable groups may be referred to as a “multi-reactive” compound. Compounds without a polymerizable group may be also referred to as “non-reactive” compounds.

As used herein, the term “director” may refer to a preferred orientation direction of long molecular axes (e.g., in case of calamitic compounds) or short molecular axes (e.g., in case of discotic compounds) of the LC or RM molecules. In a film including a uniaxially positive birefringent LC or RM material, the optic axis may be provided by the director.

The term “optic axis” may refer to a direction in a crystal. A light propagating in the optic axis direction may not experience birefringence (or double refraction). An optic axis may be a direction rather than a single line: lights that are parallel to that direction may experience no birefringence. The term “lens plane” or “lens layer” of a lens refers to a film plane or a film layer of an optically anisotropic film included in the lens.

As used herein, the term “film” and “layer” may include rigid or flexible, self-supporting or free-standing film, coating, or layer, which may be disposed on a supporting substrate or between substrates. The term “in-plane” in phrases “in-plane direction,” “in-plane orientation,” “in-plane alignment pattern,” “in-plane rotation pattern,” and “in-plane pitch” means within a plane of a film or a layer (e.g., a surface plane of the film or layer, or a plane parallel to the surface plane of the film or layer).

As used herein, the phrase “aperture of a lens” refers to an effective light receiving area of the lens. A “geometry center” of a lens refers to a center of a shape of the effective light receiving area (e.g., aperture) of the lens. The geometry center may be a point of intersection of (i.e., a crossing point between) a first symmetric axis and a second symmetric axis of the shape of the aperture. When the entire shape of the lens constitutes the effective light receiving area of the lens, the geometry center of the lens is the center of the shape of the lens. For example, when the aperture has a circular shape, the geometry center is a point of intersection of a first diameter (also a first symmetric axis) and a second diameter (also a second symmetric axis) of the aperture of the lens. When the aperture has a rectangular shape, the geometry center is a point of intersection of a longitudinal symmetric axis (also a first symmetric axis) and a lateral symmetric axis (also a second symmetric axis) of the aperture of the lens.

Pancharatnam-Berry phase (“PBP”) is a geometric phase (“GP”) related to changes in the polarization state experienced by a light while the light propagates in an optically anisotropic material. Such a geometric phase may be proportional to a solid angle defined by the polarization state along the light propagation path on the Poincarè sphere. In an optically anisotropic material, a transverse gradient of PBP may be induced by local rotations of the optic axis. When the thickness of an optically anisotropic plate corresponds to a half-wave plate phase difference between the ordinary and the extraordinary lights, the PBP between two points across a light beam profile may be equal to twice the relative rotation of the optic axis at the two points. Thus, the wavefront of the light may be polarization-dependent and may be configured by a spatial rotation of the optic axis in the in-plane.

PBP lenses may be formed by a thin layer of one or more birefringent materials with intrinsic or induced (e.g., photo-induced) optical anisotropy (referred to as an optically anisotropic film), such as liquid crystals, liquid crystal polymers, amorphous polymers, or metasurfaces. The birefringent materials may include optically anisotropic molecules. A desirable lens phase profile may be directly encoded into local orientations of the optic axis of the optically anisotropic film. PBP lenses have features such as flatness, compactness, high efficiency, high aperture ratio, absence of on-axis aberrations, possibility of switching, flexible design, simple fabrication, and low cost, etc. Thus, the GP lenses or PBP lenses can be implemented in various applications such as portable or wearable optical devices or systems.

The in-plane orientation of the optic axis of the optically anisotropic film may be determined by orientations (e.g., alignment directions) of the elongated molecules or molecular units (e.g., small molecules or fragments of polymeric molecules) in the film. For discussion purposes, elongated optically anisotropic molecules are used as examples for describing the alignment pattern in the PBP lens. The alignment of the elongated optically anisotropic molecules may also be referred to as the orientation of the directors of the elongated optically anisotropic molecules. In some embodiments, the alignment pattern may include an in-plane orientation pattern, i.e., the orientation pattern in a plane, such as a surface plane of the film or a plane parallel with the surface of the film. The in-plane orientation pattern of the optically anisotropic molecules may result in an in-plane orientation pattern of the optic axis of the optically anisotropic film. In some embodiments, the molecules may have a continuous in-plane rotation in at least two opposite directions along a film plane (e.g., a surface plane) of the optically anisotropic film. The at least two opposite in-plane directions may be opposite directions from a lens pattern center to opposite lens peripheries of the PBP lens. The least two opposite directions along the surface plane of the optically anisotropic film may be referred to as at least two opposite in-plane directions. Correspondingly, the optic axis of the optically anisotropic film may have a continuous in-plane rotation in the at least two opposite in-plane directions of the optically anisotropic film.

An in-plane orientation of the optic axis of the optically anisotropic film may correspond to an in-plane projection of the optic axis, e.g., a projection of the optic axis on a film plane. An angle formed by the projection with a predetermined reference direction in the film plane (e.g., +x-axis direction) may be defined as an azimuthal angle of the optic axis at a local point, which may be the same as the azimuthal angle of a corresponding molecule. The azimuthal angle of the optic axis (or the azimuthal angles of the molecules) may change from one local point to another local point, resulting in changes in the in-plane projection of the optic axis.

A lens pattern (or an optic axis pattern) of the PBP lens refers to the orientation pattern of the optic axis of the optically anisotropic film, or the orientation pattern of the elongated molecules or elongated molecular units, the pattern of change of the azimuthal angles of the optic axis of the optically anisotropic film, or the pattern of change of the azimuthal angles of the optically anisotropic molecules in the optically anisotropic film. The azimuthal angles of the optic axis of the optically anisotropic film may change in at least two opposite in-plane directions of the optically anisotropic film. The at least two opposite in-plane directions may be opposite directions from a lens pattern center to opposite lens peripheries of the PBP lens. At the same distance from the lens pattern center in the at least two opposite in-plane directions, the optic axis of the optically anisotropic film of the PBP lens may rotate in the same rotation direction (e.g., clockwise or counter-clockwise) respectively. The lens pattern (or the optic axis pattern) of the PBP lens may correspond to an alignment pattern of the elongated molecules or molecular units (e.g., small molecules or fragments of polymeric molecules) in the optically anisotropic film. A fringe of the PBP lens refers to a set of local points at which the azimuthal angles of the optic axis (or the rotation angles of the optic axis starting from the lens pattern center to the local points in the radial direction) are the same. The PBP lens may have a plurality of fringes. For a PBP lens functioning as a spherical lens or an aspherical lens, the fringes may be concentric rings. For a PBP lens functioning as a cylindrical lens, the fringes may be parallel lines.

A center of the lens pattern of an on-axis focusing PBP lens is referred to as a lens pattern center, which may be a symmetry center of the lens pattern. The lens pattern center of the on-axis focusing PBP lens may coincide with a geometry center of the on-axis focusing PBP lens. An off-axis focusing PBP lens may be considered as a lens obtained by shifting the lens pattern center of a corresponding on-axis focusing PBP lens with respect to the geometry center of the on-axis focusing PBP lens. The lens pattern center of the corresponding on-axis focusing PBP lens may also be a lens pattern center of the off-axis focusing PBP lens. That is, the off-axis focusing PBP lens may have an on-axis focusing counterpart with the same lens pattern center.

A geometry center of a PBP lens may be defined as a center of a shape of the effective light receiving area (i.e., an aperture) of the PBP lens. When the entire area of the PBP lens constitutes the effective light receiving area, the geometry center of the PBP lens may correspond to the center of the shape of the PBP lens. An out-of-plane geometry center axis (also referred to as a lens axis) refers to an axis passing through the geometry center that is perpendicular to the surface plane of the optically anisotropic film of the PBP lens. An in-plane geometry center axis refers to an axis passing through the geometry center that is within the surface plane of the optically anisotropic film of the PBP lens. The out-of-plane geometry center axis may be parallel with the out-of-plane lens pattern center axis.

In some embodiments, when the PBP lens is an on-axis focusing PBP lens, the lens pattern center may correspond to the geometry center of the PBP lens (i.e., the center of the shape of the effective light receiving area of the lens). In some embodiments, when the PBP lens is an off-axis focusing PBP lens, the lens pattern center of the PBP lens may not correspond to a geometry center of the PBP lens. Instead, the lens pattern center of the PBP lens may be shifted from the geometry center of the PBP lens. An “out-of-plane lens pattern center axis” refers to an axis passing through the lens pattern center that is perpendicular to the surface plane of the optically anisotropic film of the PBP lens. An in-plane lens pattern center axis refers to an axis passing through the lens pattern center that is within the surface plane of the optically anisotropic film of the PBP lens. Thus, the in-plane lens pattern center axis is perpendicular to the out-of-plane lens pattern center axis.

For a PBP lens functioning as a spherical lens or an aspherical lens (referred to as a PBP spherical lens or aspherical lens), the at least two opposite in-plane directions may include a plurality of opposite radial directions. A PBP spherical/aspherical lens may focus a light into a point (e.g., a focal point or focus). A PBP spherical/aspherical lens may have a geometry center that is a point of intersection of a first in-plane symmetric axis (e.g., a first diameter) and a second in-plane symmetric axis (e.g., a second diameter) of the shape of the aperture. In some embodiments, the lens pattern center and the geometry center of the PBP spherical/aspherical lens may be located on a same in-plane symmetric axis of the aperture of the PBP spherical/aspherical lens.

For a PBP lens functioning as an on-axis focusing PBP spherical lens or aspherical lens, the alignment pattern and the fringes of the PBP lens may be centrosymmetric with respect to the lens pattern center of the PBP lens. In addition, the fringes of the PBP lens may be symmetric with respect to an axis passing through the lens pattern center of the PBP lens. The alignment pattern of the PBP lens may be asymmetric with respect to the axis passing through the lens pattern center of the PBP lens.

For a PBP lens functioning as an off-axis focusing PBP spherical lens or aspherical lens, the alignment pattern and the fringes of the PBP lens over the entire PBP lens may not be centrosymmetric with respect to the lens pattern center of the PBP lens. Instead, the alignment pattern and the fringes of an off-axis focusing PBP lens in a predetermined region of the entire PBP lens including the lens pattern center may be centrosymmetric with respect to the lens pattern center of the PBP lens. In addition, the fringes of an off-axis focusing PBP lens in a predetermined region of the entire PBP lens including the lens pattern center may be symmetric with respect to an axis passing through the lens pattern center of the PBP lens. The alignment pattern of the PBP lens in a predetermined region of the entire off-axis focusing PBP lens including the lens pattern center may be asymmetric with respect to the axis passing through the lens pattern center of the PBP lens.

A PBP spherical lens (e.g., an on-axis or off-axis focusing PBP spherical lens) may have a point at which an azimuthal angle changing rate of the optic axis (or an azimuthal angle changing rate of the optically anisotropic molecules) of the optically anisotropic film in the opposite radial directions is the smallest, as compared to the remaining points of the PBP spherical lens. That is, in the PBP spherical lens, the azimuthal angle changing rate of the optic axis of the optically anisotropic film may be configured to increase in substantially the entire PBP lens in opposite radial directions from the lens pattern center to the opposite lens peripheries. In the PBP spherical lens, the lens pattern center may also be defined as the point at which an azimuthal angle changing rate of the optic axis (or an azimuthal angle changing rate of the optically anisotropic molecules) of the optically anisotropic film in the at least two opposite in-plane directions is the smallest. As a comparison, in a PBP aspherical lens (e.g., an on-axis or off-axis focusing PBP aspherical lens), the azimuthal angle changing rate of the optic axis of the optically anisotropic film may be configured to increase in at least a portion of the PBP lens including a lens pattern center (less than the entire PBP lens) from the lens pattern center to the opposite lens peripheries in opposite radial directions.

For a PBP lens functioning as a cylindrical lens (referred to as a PBP cylindrical lens), which may be considered as a 1D case of a PBP lens functioning as a spherical lens, the at least two opposite in-plane directions may include two opposite lateral directions. A PBP cylindrical lens may focus a light into a line (e.g., a line of focal points or line focus). A PBP cylindrical lens may have two symmetric axes of the shape of the aperture, e.g., a lateral symmetric axis in a lateral direction (or width direction) of the PBP cylindrical lens and a longitudinal symmetric axis in a longitudinal direction (or length direction) of the PBP cylindrical lens. The geometry center of the PBP cylindrical lens may be a point of intersection of the two symmetric axes. When the cylindrical lens has a rectangular shape, the geometry center may also be a point of intersection of two diagonals. A PBP cylindrical lens may have a plurality of points, at each of which an azimuthal angle changing rate of the optic axis (or an azimuthal angle changing rate of the optically anisotropic molecules) of the optically anisotropic film in the at least two opposite in-plane directions may be the smallest. The plurality of points, at each of which an azimuthal angle changing rate is the smallest may be arranged in a line. The line may be referred to as an “in-plane lens pattern center axis” of the PBP cylindrical lens. The in-plane lens pattern center axis may be in the longitudinal direction. A lens pattern center of the PBP cylindrical lens may also be considered as one of the plurality of points, which is located on a same symmetric axis (e.g., the lateral symmetric axis) with the geometry center of the PBP cylindrical lens. In other words, the lens pattern center is also a point of intersection of the in-plane lens pattern center axis and the lateral symmetric axis.

A PBP cylindrical lens may have a central symmetry of fringes and alignment pattern with respect to the lens pattern center in the two opposite lateral directions (and in some embodiments, only in the two opposite lateral directions). For a PBP lens functioning as an on-axis focusing PBP cylindrical lens, the alignment pattern and the fringes of the PBP lens over the entire PBP lens may be centrosymmetric with respect to the lens pattern center in the two opposite lateral directions (and in some embodiments, only in the two opposite lateral directions). In addition, the fringes of the PBP lens may be symmetric with respect to the in-plane lens pattern center axis of the PBP lens. The alignment pattern of the PBP lens may be asymmetric with respect to the in-plane lens pattern center axis of the PBP lens.

For a PBP lens functioning as an off-axis focusing PBP cylindrical lens, the alignment pattern and the fringes of the PBP lens over the entire PBP lens may not be centrosymmetric with respect to the lens pattern center in the two opposite lateral directions. Instead, the alignment pattern and the fringes of the PBP lens in a predetermined region of the entire PBP lens including the lens pattern center may be centrosymmetric with respect to the lens pattern center of the PBP lens in the two opposite lateral directions. In addition, the fringes of the PBP lens in the predetermined region of the entire PBP lens including the lens pattern center may be symmetric with respect to the in-plane lens pattern center axis of the PBP lens. The alignment pattern of the PBP lens in the predetermined region of the entire PBP lens including the lens pattern center may be asymmetric with respect to the in-plane lens pattern center axis of the PBP lens.

The present discourse provides an off-axis focusing GP lens or PBP lens configured to provide an off-axis focusing capability to an incoming light without tilting the off-axis focusing PBP lens. The off-axis focusing PBP lens may include an optically anisotropic film. An optic axis of the optically anisotropic film (or the off-axis focusing PBP lens) may be configured with a continuous in-plane rotation in at least two opposite in-plane directions of the optically anisotropic film from a lens pattern center, thereby creating a geometric phase profile for the off-axis focusing PBP lens. The at least two opposite in-plane directions may be opposite directions from a lens pattern center to opposite lens peripheries of the off-axis focusing PBP lens. The optic axis of the optically anisotropic film may rotate in a same rotation direction (e.g., a clockwise direction or a counter-clockwise direction) along the at least two opposite in-plane directions from the lens pattern center. The rotation of the optic axis of the optically anisotropic film in a predetermined rotation direction (e.g., a clockwise direction or a counter-clockwise direction) may exhibit a handedness, e.g., right handedness or left handedness. An azimuthal angle changing rate of the optic axis of the optically anisotropic film may be configured to increase from the lens pattern center in the at least two opposite in-plane directions in at least a predetermined portion of the off-axis focusing PBP lens including the lens pattern center. The lens pattern center may be shifted from a geometry center of the off-axis focusing PBP lens by a predetermined distance in a predetermined direction. In some embodiments, the lens pattern center of the off-axis focusing PBP lens may be a point at which the azimuthal angle changing rate of the optic axis of the optically anisotropic film is the smallest in at least the portion of the lens including the lens pattern center. In some embodiments, the lens pattern center of the off-axis focusing PBP lens may be a symmetric center of a lens pattern of a corresponding on-axis focusing PBP lens.

The lens pattern of the off-axis focusing PBP lens may have a period P that is defined as a distance over which the azimuthal angle θ of the optic axis of the optically anisotropic film changes by π in the at least two opposite in-plane directions. The period P of the lens pattern may vary in the at least two opposite in-plane directions. The period P of the lens pattern may monotonically decrease from the lens pattern center in the at least two opposite in-plane directions in at least the predetermined portion of the off-axis focusing PBP lens including the lens pattern center. In some embodiments, the predetermined portion of the off-axis focusing PBP lens including the lens pattern center may be substantially the entire off-axis focusing PBP lens. In some embodiments, the predetermined portion of the off-axis focusing PBP lens including the lens pattern center may be less than the entire off-axis focusing PBP lens. For example, the period P of the lens pattern may monotonically decrease from the lens pattern center in the at least two opposite in-plane directions in a first predetermined portion of the off-axis focusing PBP lens including the lens pattern center, and increase from the lens pattern center in the at least two opposite in-plane directions from the lens pattern center to the periphery in a second predetermined portion of the off-axis focusing PBP lens. The first predetermined portion may be different from the second predetermined portion. In some embodiments, the first predetermined portion may be adjacent to the second predetermined portion.

In some embodiments, the off-axis focusing PBP lens may be obtained by cropping or cutting an on-axis PBP lens asymmetrically. In some embodiments, the off-axis focusing PBP lens may be fabricated by one or more of holographic recording, direct writing, exposure through a master mask, or a photocopying, etc. In some embodiments, the orientation pattern of the optic axis of the optically anisotropic film may be holographically recorded in a layer of a recording medium by two coherent polarized lights. In some embodiments, the two polarized lights may be two circularly polarized lights with opposite handednesses irradiated onto the same surface of the recording medium. The fabricated off-axis focusing PBP lens may be a transmissive type optical element. In some embodiments, one of the two circularly polarized lights may be a collimated light and the other may be a converging or diverging light.

In some embodiments, the two circularly polarized lights may be two circularly polarized lights with a same handedness irradiated onto different surfaces (e.g., two opposite surfaces) of the recording medium. The fabricated off-axis focusing PBP lens may be a reflective type optical element. In some embodiments, one of the two circularly polarized lights may be a collimated light and the other may be a converging or diverging light.

The recording medium may include one or more optically recordable and polarization sensitive materials configured to generate a photo-induced anisotropy when subjected to a polarized light irradiation. The molecules (fragments) and/or the photo-products of the recording medium may be configured to generate orientational ordering under a light irradiation. The interference of the two circularly polarized lights may result in patterns of light polarization (or polarization interference patterns), without resulting in intensity modulation. In some embodiments, the molecules of the optically recordable and polarization sensitive materials may include elongated anisotropic photo-sensitive units (e.g., small molecules or fragments of polymeric molecules). The patterns of light polarization may induce a local alignment direction of the anisotropic photo-sensitive units in the layer of recording medium, resulting in a modulation of an optic axis due to a photo-alignment of the anisotropic photo-sensitive units. The optic axis orientation inscribed in the recording medium may be further enhanced by disposing a layer of birefringent materials having an intrinsic birefringence, such as liquid crystals (“LCs”) or reactive mesogens (“RMs”), on the recording medium. LCs or RMs may be aligned along the local alignment direction of the anisotropic photo-sensitive units in the layer of the recording medium. Thus, the orientational pattern of the optic axis in the recording medium may be transferred to the LCs or RMs. That is, the irradiated layer of the recording medium may function as an photo-alignment (“PAM”) layer for the LCs or RMs. Such an alignment procedure may be referred to as a surface-mediated photo-alignment.

In some embodiments, the photo-alignment of photo-sensitive units may occur in a volume of one or more optically recordable and polarization sensitive materials. When irradiation is provided with holographically created patterns of light polarization, the alignment patterns of photo-sensitive units may occur in the layer of the recording medium. Such an alignment procedure may be referred to as a bulk-mediated photo-alignment. In some embodiments, the optically recordable and polarization sensitive materials for bulk-mediated photo-alignment may include photo-sensitive polymers, such as amorphous polymers, liquid crystal (“LC”) polymers, etc. In some embodiments, the amorphous polymers may be initially optically isotropic prior to undergoing the recording process, and may exhibit an induced (e.g., photo-induced) optical anisotropy during the recording process. In some embodiments, the birefringence and orientational patterns may be recorded in the LC polymers due to an effect of photo-induced optical anisotropy. The photo-induced optical anisotropy in the LC polymers may be considerably enhanced by a subsequent heat treatment (e.g., annealing) in a temperature range corresponding to liquid crystalline state of the LC polymers due to intrinsic self-organization of mesogenic fragments of the LC polymers.

The molecules of photo-sensitive polymers may include polarization sensitive photo-reactive groups embedded in a main or a side polymer chain. In some embodiments, the polarization sensitive groups may include an azobenzene group, a cinnamate group, or a coumarin group, etc. In some embodiments, the photo-sensitive polymer may include an LC polymer with a polarization sensitive cinnamate group incorporated in a side polymer chain. An example of the LC polymer with a polarization sensitive cinnamate group incorporated in a side polymer chain is a polymer M1. The polymer M1 has a nematic mesophase in a temperature range of about 115° C. to about 300° C. An optical anisotropy may be induced by irradiating the M1 film with a polarized UV light (e.g., a laser light with a wavelength of 325 nm or 355 nm) and subsequently enhanced by more than an order of magnitude by annealing at a temperature range of about 115° C. to about 300° C. It is to be noted that the material M1 is for illustrative purposes, and is not intended to limit the scope of the present disclosure. The dependence of the photo-induced birefringence on exposure energy is qualitatively similar for other materials from liquid crystalline polymers of M series. Liquid crystalline polymers of M series are discussed in U.S. patent application Ser. No. 16/443,506, filed on Jun. 17, 2019, titled “Photosensitive Polymers for Volume Holography,” which is incorporated by reference for all purposes. In some embodiments, with suitable photo-sensitizers, a visible light (e.g., a violet light) may also be used to induce anisotropy in this material.

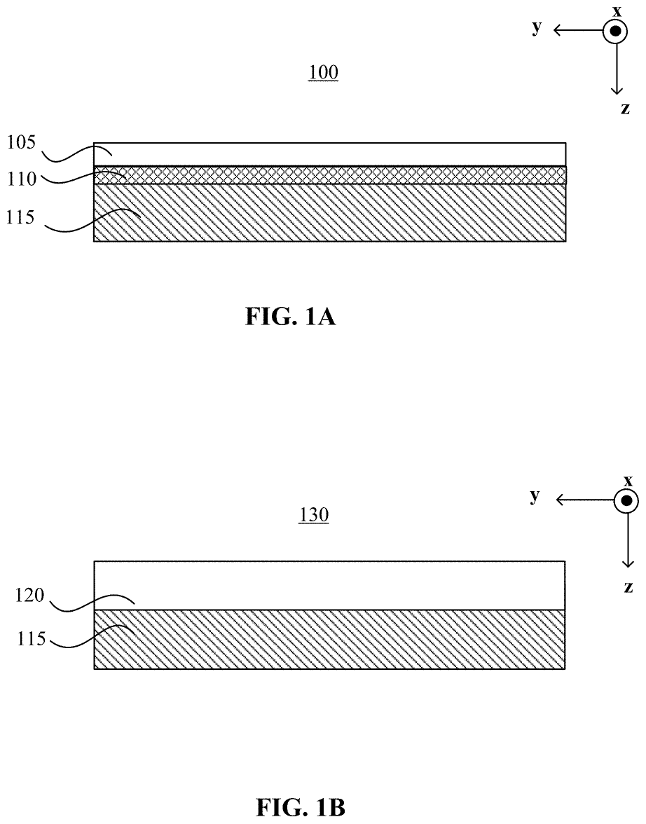

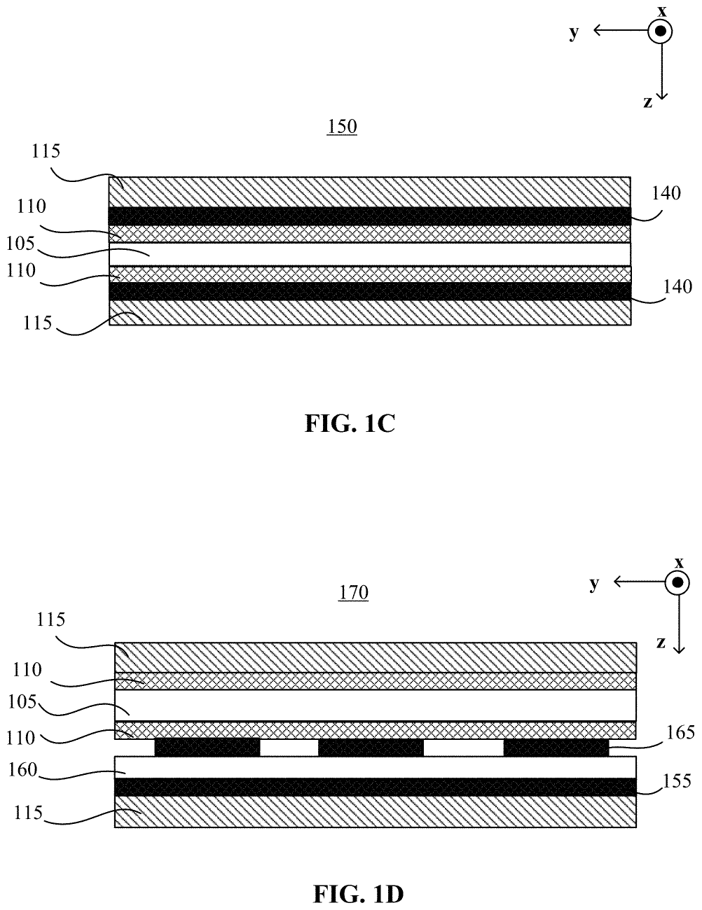

FIG. 1A illustrates a schematic diagram of an off-axis focusing PBP lens 100 according to an embodiment of the present disclosure. The off-axis focusing PBP lens 100 may be fabricated based on the surface-mediated photo-alignment technology. As shown in FIG. 1A, the off-axis focusing PBP lens 100 may include an optically anisotropic film 105 and an alignment layer 110 (e.g., a PAM layer 110) coupled to the optically anisotropic film 105. The PAM layer 110 may include one or more recording media, where a predetermined local orientation pattern of the optic axis of the birefringent material has been directly recorded in the photo-alignment process. For example, the PAM layer 110 may provide a planar alignment (or an alignment with a small pretilt angle, e.g., smaller than 15 degrees) that is in-plane patterned to provide a lens pattern. The optically anisotropic film 105 may include one or more birefringent materials having an intrinsic birefringence, such as LCs or RMs. The PAM layer 110 may at least partially align the LCs or RMs in the optically anisotropic film 105 that are in contact with the PAM layer 110, such that the local orientational pattern of the optic axis recorded in the PAM layer 110 may be transferred to the LCs or RMs in the optically anisotropic film 105. In some embodiments, the optically anisotropic film 105 may be configured to have local optic axis orientations that vary (e.g., non-linearly) in at least one direction along a surface of the optically anisotropic film 105 to define a lens pattern having a varying pitch. In some embodiments, RMs may be mixed with photo- or thermo-initiators, such that the aligned RMs may be in-situ photo- or thermo-polymerized/crosslinked to solidify the film and stabilize the alignment pattern of the RMs in the optically anisotropic film 105. In some embodiments, LCs may be mixed with photo- or thermo-initiators and polymerizable monomers, such that the aligned LCs may be in-situ photo- or thermo-polymerized/crosslinked to solidify the film and stabilize the alignment pattern of the LCs in the optically anisotropic film 105.

In some embodiments, the PAM layer 110 may be used to fabricate, store, or transport the off-axis focusing PBP lens 100. In some embodiments, the PAM layer 110 may be detachable or removable from other portions of the off-axis focusing PBP lens 100 after the other portions of the off-axis focusing PBP lens 100 are fabricated or transported to another place or device. That is, the PAM layer 110 may be used in fabrication, transportation, and/or storage to support the optically anisotropic film 105 provided at a surface of the PAM layer 110, and may be separated or removed from the optically anisotropic film 105 of the off-axis focusing PBP lens 100 when the fabrication of the off-axis focusing PBP lens 100 is completed, or when the off-axis focusing PBP lens 100 is to be implemented in an optical device.

In some embodiments, the off-axis focusing PBP lens 100 may include one or more substrates 115 for support and protection purposes. The optically anisotropic film 105 may be disposed at (e.g., formed at, attached to, deposited at, bonded to, etc.) a surface of the substrate 115. For discussion purposes, FIG. 1A shows that the off-axis focusing PBP lens 100 includes one substrate 115. In some embodiments, the substrate 115 may be a substrate where the recording film is disposed during the recording process of the off-axis focusing PBP lens 100. The substrate 115 may be transparent and/or reflective in one or more predetermined spectrum bands. In some embodiments, the substrate 115 may be transparent and/or reflective in at least a portion of the visible band (e.g., about 380 nm to about 700 nm). In some embodiments, the substrate 115 may be transparent and/or reflective in at least a portion of the infrared (“IR”) band (e.g., about 700 nm to about 1 mm). In some embodiments, the substrate 115 may be transparent and/or reflective in at least a portion of the visible band and at least a portion of the IR band. The substrate 115 may be fabricated based on an organic material and/or an inorganic material that is substantially transparent to the light of above-listed spectrum bands. The substrate 115 may be rigid or flexible. The substrate 115 may have flat surfaces or at least one curved surface, and the optically anisotropic film 105 disposed at (e.g., formed at, attached to, deposited at, bonded to, etc.) the curved surface may also have a curved shape. In some embodiments, the substrate 115 may also be a part of another optical element, another optical device, or another opto-electrical device. In some embodiments, the substrate 115 may be a part of a functional device, such as a display screen. In some embodiments, the substrate 115 may be a part of an optical waveguide fabricated based on a suitable material, such as glass, plastics, sapphire, or a combination thereof. In some embodiments, the substrate 115 may be a part of another optical element or another optical device. In some embodiments, the substrate 115 may be a conventional lens, e.g., a glass lens. Although one substrate 115 is shown in FIG. 1A, in some embodiments, the off-axis focusing PBP lens 100 may include two substrates 115 sandwiching the optically anisotropic film 105. In some embodiments, each substrate 115 may be disposed with a PAM layer 110 configured to provide an alignment of the LCs or RMs in the optically anisotropic film 105.

In some embodiments, the substrate 115 may be used to fabricate, store, or transport the off-axis focusing PBP lens 100. In some embodiments, the substrate 115 may be detachable or removable from other portions of the off-axis focusing PBP lens 100 after the other portions of the off-axis focusing PBP lens 100 are fabricated or transported to another place or device. That is, the substrate 115 may be used in fabrication, transportation, and/or storage to support the PAM layer 110 and the optically anisotropic film 105 provided on the substrate 115, and may be separated or removed from the PAM layer 110 and the optically anisotropic film 105 when the fabrication of the off-axis focusing PBP lens 100 is completed, or when the off-axis focusing PBP lens 100 is to be implemented in an optical device.

FIG. 1B illustrates a schematic diagram of an off-axis focusing PBP lens 130 according to an embodiment of the present disclosure. The off-axis focusing PBP lens 130 may be fabricated based on bulk-mediated photo-alignment technology. As shown in FIG. 1B, the off-axis focusing PBP lens 130 may include an optically anisotropic film 120. The optically anisotropic film 120 may include one or more materials configured to generate a photo-induced birefringence, such as amorphous or liquid crystal polymers with polarization sensitive photo-reactive groups. The optically anisotropic film 120 shown in FIG. 1B may be relatively thicker than the PAM layer 110 shown in FIG. 1A. A predetermined local orientation pattern of the optic axis of the optically anisotropic film 120 may be directly recorded in the optically anisotropic film 120 via bulk-mediated photo-alignment during the recording process. The optically anisotropic film 120 may be configured to have local optic axis orientations that vary non-linearly in at least one direction along a surface of the optically anisotropic film 120 to define a pattern having a varying pitch. In some embodiments, the off-axis focusing PBP lens 130 may also include one or more substrates 115 for support and protection purposes. Detailed descriptions of the substrate 115 may refer to the above descriptions rendered in connection with FIG. 1A. Although one substrate 115 is shown in FIG. 1B, in some embodiments, the off-axis focusing PBP lens 130 may include two substrate 115 sandwiching the optically anisotropic film 120.

FIG. 1C illustrates a schematic diagram of an off-axis focusing PBP lens 150 according to an embodiment of the present disclosure. The off-axis focusing PBP lens 150 shown in FIG. 1C may include elements that are the same as or similar to those included in the off-axis focusing PBP lens 100 shown in FIG. 1A. Detailed descriptions of the same or similar elements may refer to the above descriptions rendered in connection with FIG. 1A. As shown in FIG. 1C, the optically anisotropic film 105 may be disposed (e.g., sandwiched) between two substrates 115. In some embodiments, as FIG. 1C shows, each substrate 115 may be provided with a conductive electrode 140 and the PAM layer 110. The electrode 140 may be disposed between the PAM layer 110 and the substrate 115. The PAM layer 110 may be disposed between the electrode 140 and the optically anisotropic film 105, and configured to provide a planar alignment (or an alignment with a small pretilt angle) that is in-plane patterned to provide a lens pattern. The electrode 140 may be transmissive and/or reflective at least in the same spectrum band as the substrate 115. The electrode 140 may be a continuous planar electrode or a pattern electrode. FIG. 1C shows the electrode 140 as a continuous planar electrode. A driving voltage may be applied to the electrodes 140 disposed at two opposite substrates 115 to generate a vertical electric field perpendicular to the substrates 115 in the optically anisotropic film 105. The electric field may reorient the anisotropic molecules, thereby switching the optical properties of the off-axis focusing PBP lens 100. The vertical electric field may realize an out-of-plane reorientation of anisotropic molecules in the optically anisotropic film 105. The term “out-of-plane reorientation” refers to rotation (or reorientation) of the directors of the optically anisotropic molecules in a direction non-parallel with (hence out of) a surface plane of the optically anisotropic film 105. Although not shown in FIG. 1C, in some embodiments, one of the two substrates 115 may be provided with the PAM layer 110, and the other one of the two substrates 115 may not be provided with a PAM layer.

FIG. 1D illustrates a schematic diagram of an off-axis focusing PBP lens 170 according to an embodiment of the present disclosure. The off-axis focusing PBP lens 170 shown in FIG. 1D may include elements that are the same as or similar to those included in the off-axis focusing PBP lens 100 shown in FIG. 1A. Detailed descriptions of the same or similar elements may refer to the above descriptions rendered in connection with FIG. 1A. As shown in FIG. 1D, the optically anisotropic film 105 may be disposed (e.g., sandwiched) between two substrates 115. At least one (e.g., each) of the substrates 115 may be provided with the PAM layer 110. In some embodiments, each of the PAM layers 110 disposed at the two substrate 115 may be configured to provide a planar alignment (or an alignment with a small pretilt angle) that is in-plane patterned to provide a lens pattern. In some embodiments, the PAM layer 110 disposed at each of two the substrate 115 may be configured to provide a planar alignment (or an alignment with a small pretilt angle) that is in-plane patterned to provide a lens pattern. The PAM layers 110 disposed at the two substrate 115 may be configured to provide parallel surface alignments or anti-parallel surface alignments. In some embodiments, the PAM layers 110 disposed at the two substrate 115 may be configured to provide hybrid surface alignments. For example, the PAM layer 110 disposed at one of two the substrate 115 may be configured to provide a planar alignment (or an alignment with a small pretilt angle) that is in-plane patterned to provide a lens pattern, and the PAM layer 110 disposed at the other substrate 115 may be configured to provide a homeotropic alignment. In some embodiments, an upper electrode 165 and a lower electrode 155 may be disposed at the same substrate 115 (e.g., a bottom substrate 115 shown in FIG. 1D). In some embodiments, the lower electrode 155 may be disposed directly on a surface of the bottom substrate 115. An electrically insulating layer 160 may be disposed between the upper electrode 165 and the lower electrode 155. The PAM layer 110 provided at the bottom substrate 115 may be disposed between the upper electrode 165 and the optically anisotropic film 105. In some embodiments, the lower electrode 155 may include a planar electrode and the upper electrode 165 may include a patterned electrode (e.g., a plurality of striped interleaved electrodes arranged in parallel). A voltage may be applied to the upper electrode 165 and the lower electrode 155 disposed at the same substrate 115 (e.g., the lower substrate 115) to generate a horizontal electric field in the optically anisotropic film 105 to reorient the anisotropic molecules, thereby switching the optical properties of the off-axis focusing PBP lens 100. The horizontal electric field may realize an in-plane reorientation of the anisotropic molecules in the optically anisotropic film 105. In some embodiments, other configurations of the electrodes for generating a horizontal electric field in the optically anisotropic film 105 may be used. For example, another configuration of the electrodes may include interdigital electrodes (e.g. in-plane switching electrodes) disposed at the same substrate for an in-plane switching of the anisotropic molecules. Although not shown, in some embodiments, one of the substrates 115 may be provided with the PAM layer 110, and the other one of the substrates 115 may not be provided with the PAM layer 110.

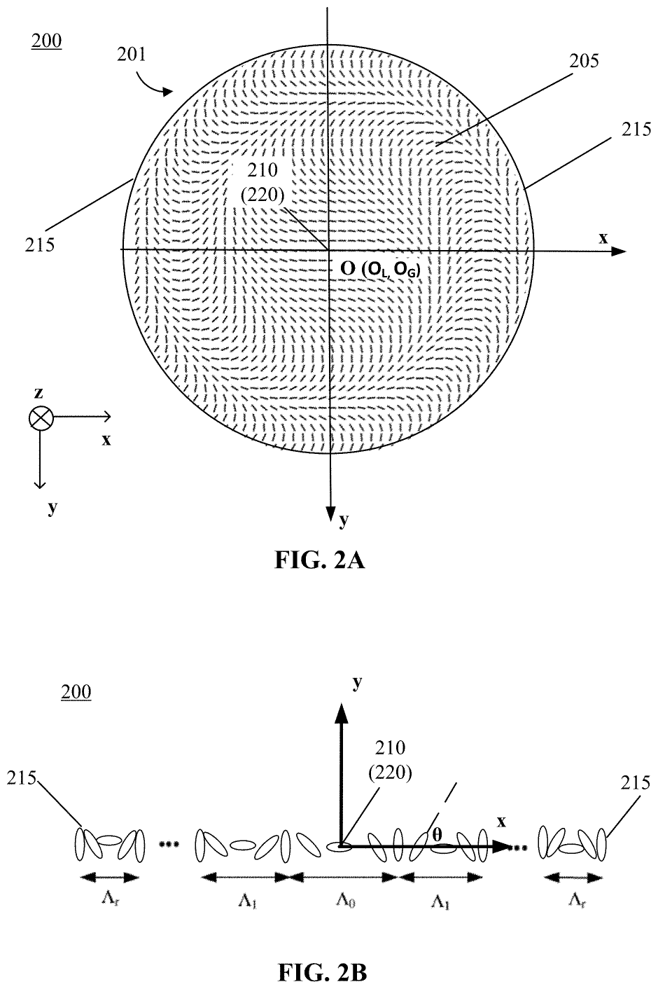

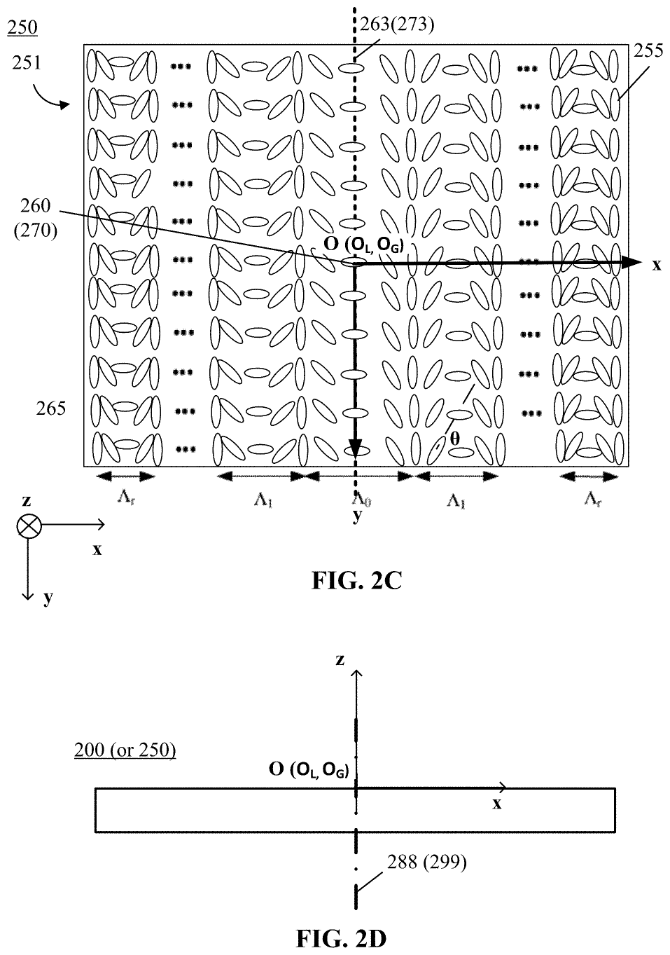

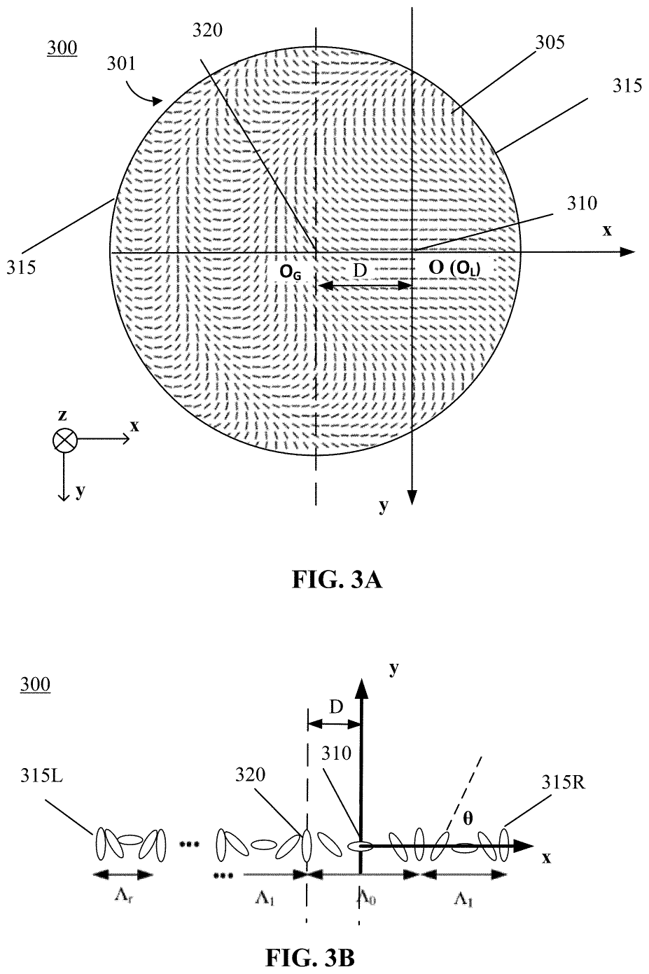

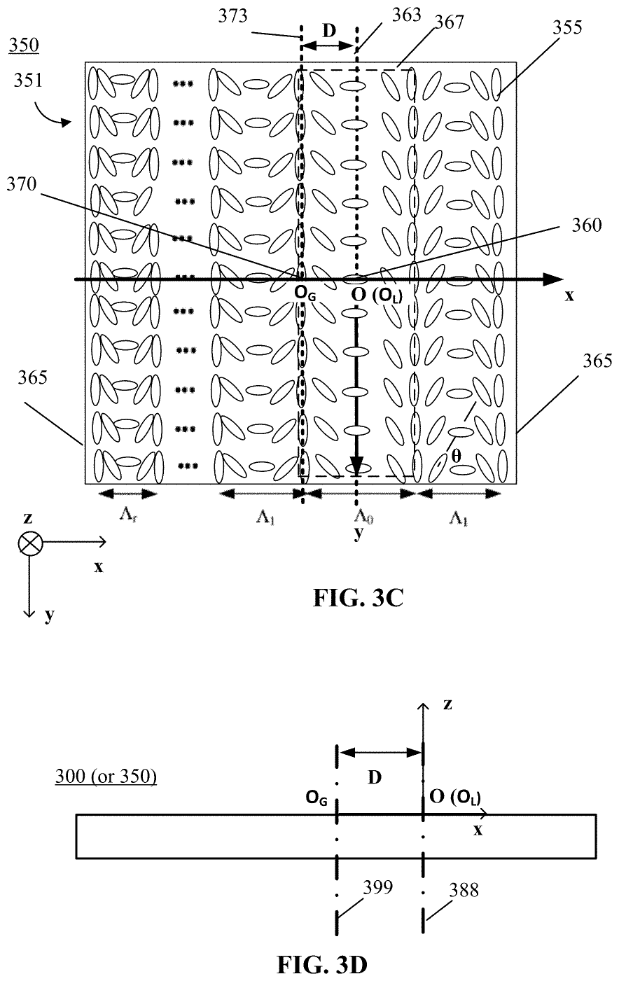

In the following, orientation of the anisotropic molecules in an off-axis focusing PBP lens will be described in detail. For discussion purposes, calamitic (rod-like) LC molecules will be used as examples of the anisotropic molecules. FIGS. 2A and 2B illustrate an LC alignment pattern in an on-axis focusing PBP lens functioning as a spherical lens (referred to as an on-axis focusing PBP spherical lens). FIG. 2C illustrates an LC alignment pattern in an on-axis focusing PBP lens functioning as a cylindrical lens (referred to as an on-axis focusing PBP cylindrical lens). FIG. 2D illustrates a side view of an on-axis focusing PBP lens shown in FIG. 2A or FIG. 2C with an out-of-plane lens pattern center axis coinciding with an out-of-plane geometry center axis passing through a geometry center of the optically anisotropic film of the lens. FIGS. 3A and 3B illustrate an LC alignment pattern in an off-axis focusing PBP lens functioning as a spherical lens (referred to as an off-axis focusing PBP spherical lens). FIG. 3C illustrates an LC alignment pattern in an off-axis focusing PBP lens functioning as a cylindrical lens (referred to as an off-axis focusing PBP cylindrical lens). FIG. 3D illustrates a side view of an off-axis focusing PBP lens shown in FIG. 3A or FIG. 3C with an out-of-plane lens pattern center axis shifted from an out-of-plane geometry center axis for a predetermined distance.

For a recorded PBP lens including an optically anisotropic film, FIG. 2A, FIG. 2C, FIG. 3A, and FIG. 3C each show a cross-sectional view (viewed in the z-axis direction or the thickness direction) of a surface plane (e.g., the x-y plane) taken at a film layer or a lens layer (e.g., a layer including the optically anisotropic film) of the PBP lens. The x-y plane represents the surface plane or a plane parallel with the surface plane of the optically anisotropic film. The x-y plane may also be a light receiving plane. That is, the light may be incident onto the lens from the z-axis direction or a direction non-parallel with the x-y plane. The z-axis is an axis perpendicular to the film layer or the lens layer, which may be in the thickness direction of the PBP lens.

FIG. 2A illustrates an LC alignment pattern (or a lens pattern) in a lens layer of an on-axis focusing PBP lens 200 functioning as a spherical lens. FIG. 2B illustrates a section of an LC director field taken along an x-axis in the on-axis focusing PBP lens 200 shown in FIG. 2A. FIG. 2A shows that the on-axis focusing PBP lens 200 has a circular shape. The origin (point “O” in FIG. 2A) of the x-y plane corresponds to a lens pattern center (O_{L}) 210 and a geometry center (O_{G}) of the effective light receiving area of the on-axis focusing PBP lens 200. That is, in the on-axis focusing PBP lens 200, the lens pattern center O_{L} may coincide with the geometry center O_{G}. For discussion purposes, the entire circular area of the lens is presumed to be the effective light receiving area (or the aperture). Thus, the geometry center (O_{G}) 220 is a center of the circular shape of the lens 200 (or of an aperture of the lens 200).

As shown in FIG. 2A, the on-axis focusing PBP lens 200 may include an optically anisotropic film 201. The optically anisotropic film 201 may include one or more birefringent materials including LC molecules 205. The lens layer refers to a layer of the optically anisotropic film 201 included in the on-axis focusing PBP lens 200. The directors of the LC molecules may be configured with a continuous in-plane rotation pattern, or the azimuthal angles of the LC molecules may be configured with a continuous in-plane changing pattern. As a result, an optic axis of the optically anisotropic film 201 may have a continuous in-plane rotation pattern. As shown in FIG. 2B, the optic axis (or the azimuthal angles of the LC molecules, or the orientation of the directors of the LC molecules) may have an in-plane rotation or orientation pattern from the lens pattern center (O_{L}) 210 to a lens periphery 215 of the on-axis focusing PBP lens 200 in a plurality of radial directions. In some embodiments, when the azimuthal angle changes in a radial direction, the azimuthal angle changing rate may not be constant along the radial direction. The azimuthal angle changing rate of the optic axis of the optically anisotropic film 201 may increase from the lens pattern center (O_{L}) 210 to the lens periphery 215 of the on-axis focusing PBP lens 200 in the radial directions. The lens pattern center (O_{L}) 210 of the on-axis focusing PBP lens 200 may be a point at which the azimuthal angle changing rate is the smallest. That is, the in-plane rotation of the optic axis of the optically anisotropic film 201 may accelerate from the lens pattern center (O_{L}) 210 to the lens periphery 215 in a plurality of radial directions.

In some embodiments, the azimuthal angle of the optic axis of the optically anisotropic film 201 may change in proportional to the distance from the lens pattern center to a local point on the optic axis. For example, the azimuthal angle of the optic axis of the optically anisotropic film 201 may change according to an equation of

$$θ = \frac{{π r}^{2}}{2 L λ} ,$$

where θ is the azimuthal angle of the optic axis at a local point of the optically anisotropic film 201, r is a distance from the lens pattern center (O_{L}) 210 of the optic lens (also the origin O of the x-y plane) to the local point in the lens plane, L is a distance between a lens plane and a focal plane of the PBP lens 200 (i.e., the focal distance in case of an on-axis focusing PBP lens), and λ is a wavelength of a light incident onto the on-axis focusing PBP lens 200. The azimuthal angle changing rate (that is a changing rate of θ or a rotational velocity of θ) is a derivative

$$\frac{d θ}{dr} = \frac{π}{L λ} r ,$$

which is zero when r=0. Thus, the point at which r=0 may be a point with the smallest rotation rate of θ or the smallest azimuthal angle changing rate.

In some embodiments, the optically anisotropic film 201 may include calamitic (rod-like) LC molecules 205. The LC molecules 205 may be aligned with directors of the LC molecules 205 (or LC directors) arranged in a continuous in-plane rotation pattern. As a result, the optic axis of the optically anisotropic film 201 may be configured in a continuous in-plane rotation pattern. As shown in FIG. 2A, the on-axis focusing PBP lens 200 may be a half-wave retarder (or half-wave plate) with LC molecules 205 aligned in a modulated in-plane alignment pattern, which may create a lens profile. Orientations of the LC directors (or azimuthal angles (θ) of the LC molecules 205) may be configured with a continuous in-plane rotation pattern with a varying pitch from a lens pattern center 210 to a lens periphery 215 in a plurality of radial directions. Thus, an optic axis of the optically anisotropic film 201 may be configured with a continuous in-plane rotation pattern with a varying pitch from the lens pattern center 210 to the lens periphery 215 in the radial directions. A pitch A of the continuous in-plane rotation is defined as a distance over which the azimuthal angle (θ) of the LC molecule 205 (or the orientation of the LC directors) changes by a predetermined amount (e.g., 180°). The pitch A of the continuous in-plane rotation may be equal to the period P of the lens pattern.

As shown in FIG. 2B, according to the LC director field along the x-axis, the pitch A may be a function of the distance from the lens pattern center 210. The pitch may monotonically decrease from the lens pattern center 210 to the lens periphery 215 in a radial direction in the x-y plane, i.e., Λ₀>Λ₁> . . . >Λᵣ, where Λ₀ is the pitch at a central region of the lens pattern including the lens pattern center 210, which may be the largest. The pitch Λᵣ is the pitch at an edge region of the lens pattern, which may be the smallest. The lens pattern center (O_{L}) 210 may be a point at which the azimuthal angle changing rate is the smallest.

In the x-y plane, the LC director of the LC molecules 205 may continuously rotate in a rotation pattern having a varying pitch (Λ₀, Λ₁, . . . , Λᵣ) along the opposite radial axes or directions, and an LC director field may have a rotational symmetry about the lens pattern center (O_{L}) 210. In the on-axis focusing PBP lens 200 shown in FIGS. 2A and 2B, the lens pattern center (O_{L}) 210 may coincide with the geometry center (O_{G}) 220 of an effective light receiving area or a lens aperture of the lens 200. In some embodiments, the geometry center may also be referred to as an aperture center. In the embodiment shown in FIG. 2A, the geometry center (O_{G}) 220 is a center of the circular shape, and coincides with the lens pattern center (O_{L}) 210. As the lens pattern center (O_{L}) 210 coincides with the geometry center (O_{G}) 220, the pitch may also be a function of the distance from the geometry center (O_{G}) 220 of the on-axis focusing PBP lens 200.

The on-axis focusing PBP lens 200 may be a PBP grating with a varying periodicity in the opposite radial directions, from the lens pattern center (O_{L}) 210 to the opposite lens peripheries 215. A period P of the lens pattern of the on-axis focusing PBP lens 200 may be defined as a distance over which the azimuthal angle θ of the optic axis of the optically anisotropic film 201 changes by π in the radial directions. Fringes of the PBP grating (i.e., the on-axis focusing PBP lens 200) may have a central symmetry about the lens pattern center (O_{L}) 210. A fringe of the PBP grating refers to a set of local points at which the azimuthal angle of the optic axis (or the rotation angle of the optic axis starting from the lens pattern center (O_{L}) 210 to the local point in the radial direction) is the same. For example, when the rotation angle of the optic axis starting from the lens pattern center (O_{L}) 210 to the local point in the radial direction is expressed as θ=θ₁+nπ (0<θ₁<π), both θ₁ and n may be the same for the local points on the same fringe. A difference in the rotation angle θ of the neighboring fringes is π, i.e., the distance between the neighboring fringes is a period P. The set of local points corresponding to the same θ may be on the same circle for an on-axis focusing PBP lens functioning as a spherical lens or an aspherical lens.

In some embodiments, the azimuthal angle (or rotation angle) θ may monotonically change approximately according to the equation

$$θ = \frac{{π r}^{2}}{2 L λ} ,$$

providing a quadratic phase shift

$$Γ = 2 θ = \frac{{π r}^{2}}{L λ}$$

for a PBP spherical lens, where r is a distance from the lens pattern center (O_{L}) 210 to a local point on the lens, and L is a distance between a lens plane and a focal plane. At a local point at which the distance r is much longer than the period P of the lens pattern (r>>P), the period P may change according to an equation

$$P \approx \frac{L λ}{2} * \frac{1}{r} .$$

That is, the period P of the lens pattern may be roughly inversely proportional to the distance r from the lens pattern center (O_{L}) 210 to the local point on the optic axis. In some embodiments, the period P of the lens pattern of an on-axis focusing PBP lens may not monotonically change (e.g., may not monotonically decrease) in the opposite radial directions from a lens pattern center (O_{L}) to opposite lens peripheries in the entire lens. Instead, the period P of the lens pattern of the on-axis focusing PBP lens may monotonically change (e.g., monotonically decrease) only in a portion of the lens including the lens pattern center (O_{L}) (less than the entire lens), in the opposite radial directions from a lens pattern center (O_{L}) to opposite lens peripheries. Accordingly, the on-axis focusing PBP lens may functions as an aspherical PBP lens (referred to as an on-axis focusing PBP aspherical lens). For example, the period P of the lens pattern of the on-axis focusing PBP aspherical lens may first decrease then increase in the radial directions from the lens pattern center (O_{L}) to the lens periphery. The lens pattern center (O_{L}) may correspond to a geometry center in the on-axis focusing PBP aspherical lens.

FIG. 2C illustrates an LC alignment pattern in a lens layer of an on-axis focusing PBP lens 250 functioning as an on-axis focusing cylindrical lens. The on-axis focusing PBP lens functioning as an on-axis focusing cylindrical lens may have a rectangular shape at a surface plane (i.e., the x-y plane). The on-axis focusing PBP lens 250 may include an optically anisotropic film 251 that includes one or more birefringent materials including LC molecules 255. The lens layer refers to a layer of the optically anisotropic film 251 included in the on-axis focusing PBP lens 250. The origin (point “O” in FIG. 2C) of the x-y plane corresponds to a lens pattern center (O_{L}) 260. The lens pattern center (O_{L}) 260 may be a point at which the azimuthal angle changing rate is the smallest. A geometry center (O_{G}) 270 of the on-axis focusing PBP lens 250 may be the center of the rectangular lens shape. The lens pattern center (O_{L}) 260 and the geometry center (O_{G}) 270 of the on-axis focusing PBP lens 250 may be located on a same symmetric axis (e.g., the lateral symmetric axis) of the on-axis focusing PBP lens 250 (e.g., the x-axis). In the on-axis focusing PBP lens 250, the geometry center (O_{G}) 270 may coincides with the lens pattern center (O_{L}) 260.

For the on-axis focusing PBP lens 250 having a rectangular shape (or a rectangular lens aperture), a width direction of the on-axis focusing PBP lens 250 may be referred to as a lateral direction (e.g., an x-axis direction in FIG. 2C), and a length direction of the on-axis focusing PBP lens 250 may be referred to as a longitudinal direction (e.g., a y-axis direction in FIG. 2C). An in-plane lens pattern center axis 263 may be an axis parallel to the longitudinal direction in the surface plane (e.g., x-y plane) and passing through the lens pattern center (O_{L}) 260. The in-plane lens pattern center axis 263 may be parallel to the y-axis direction, as shown in FIG. 2C. An in-plane geometry center axis 273 of the on-axis focusing PBP lens 250 may be an axis parallel to the longitudinal direction in the surface plane (e.g., x-y plane) and passing through the geometry center (O_{G}) 270. In the embodiment shown in FIG. 2C, the in-plane lens pattern center axis 263 may coincide with the in-plane geometry center axis 273.

An optic axis of the optically anisotropic film 251 may be configured with a continuous in-plane rotation pattern from the lens pattern center (O_{L}) 260 to a lens periphery 265 of the on-axis focusing PBP lens 250 in the lateral direction (e.g., the x-axis direction). An azimuthal angle changing rate of the optic axis of the optically anisotropic film 251 may increase from the lens pattern center (O_{L}) 260 to the lens periphery 265 in the lateral direction. That is, the continuous in-plane rotation of the optic axis of the optically anisotropic film of the on-axis focusing PBP lens 250 may accelerate from the lens pattern center (O_{L}) 260 to the lens periphery 265 in the lateral direction. The azimuthal angles of the optic axis at locations on the same side of the in-plane lens pattern center axis 263 and having a same distance from the in-plane lens pattern center axis 263 in the lateral direction, may be substantially the same.

The on-axis focusing PBP lens 250 may be a PBP grating with a varying periodicity in the opposite lateral directions from the in-plane lens pattern center axis 263 to the opposite lens periphery 265 (e.g., to the left side lens periphery and to the right side lens periphery). A period P of the lens pattern of the on-axis focusing PBP lens 250 may be defined as a distance over which the azimuthal angle θ of the optic axis of the optically anisotropic film 251 changes by π in the radial directions. Fringes of the PBP grating may have an axial symmetry about the in-plane lens pattern center axis 263. The alignment pattern of the PBP grating may be asymmetric about the in-plane lens pattern center axis 263. A fringe of the PBP grating (i.e., the on-axis focusing PBP lens 250) refers to a set of local points at which the azimuthal angle of the optic axis (or the rotation angle of the optic axis starting from the in-plane lens pattern center axis 263 to the local point in the lateral direction) is the same. For example, when the rotation angle of the optic axis from the in-plane lens pattern center axis 263 to the local point in the lateral direction is expressed as θ=θ₁+nπ (0<θ₁<π), both θ₁ and n may be the same for the local points on the same fringe. A difference in the rotation angles of the neighboring fringes is π, i.e., the distance between the neighboring fringes is the period P. The set of local points may be on the same line parallel to the longitudinal direction for the on-axis focusing PBP lens 250 functioning as cylindrical lens.

In some embodiments, the on-axis focusing PBP lens 250 functioning as a cylindrical lens may be considered to have a central symmetry of fringes and alignment pattern with respect to the lens pattern center in the two opposite lateral directions (and in some embodiments, only in the two opposite lateral directions). The equation

$$θ = \frac{π {r}^{2}}{2 L λ}$$

and corresponding phase shift equation

$$Γ = 2 θ = \frac{π {r}^{2}}{L λ}$$

for a PBP spherical lens may also be applied to the on-axis focusing PBP lens 250 functioning as a cylindrical lens, but only in the two opposite lateral directions. That is, r is a distance from the lens pattern center (O_{L}) 260 to a local point of the on-axis focusing PBP lens 250 in the two opposite lateral directions. In this sense, cylindric lens can be considered as a 1d case of spherical lens.

In some embodiments, the optically anisotropic film 251 may include calamitic (rod-like) LC molecules 255. The directors of the LC molecules 255 (LC directors) may continuously rotate within the surface plane, resulting in a continuous in-plane rotation of the optic axis. As shown in FIG. 2C, the on-axis focusing PBP lens 250 may be a half-wave retarder (or half-wave plate) with LC molecules 255 aligned in a modulated in-plane alignment pattern, which may create a lens profile. Directors of the LC molecules 255 (or azimuthal angles (θ) of the LC molecules 255) may be configured with a continuous in-plane rotation pattern with a varying pitch (Λ₀, Λ₁, . . . , Λᵣ) from the lens pattern center (O_{L}) 260 to the lens periphery 265 in the lateral direction (e.g., an x-axis direction in FIG. 2C). The orientations of the directors of the LC molecules 255 (the LC directors) located on the same side of the in-plane lens pattern center axis 263 and at a same distance from the in-plane lens pattern center axis 263 may be substantially the same. As shown in FIG. 2C, the pitch of the lens pattern may be a function of the distance to the in-plane lens pattern center axis 263 in the lateral direction. In some embodiments, the pitch of the lens pattern may monotonically decrease as the distance to the in-plane lens pattern center axis 263 in the lateral direction increases, i.e., Λ₀>Λ₁> . . . >Λᵣ, where Λ₀ is the pitch at a central portion of the lens pattern, which may be the largest. The pitch Λᵣ is the pitch at an edge region of the lens pattern, which may be the smallest.

FIG. 2D illustrates a side view of an on-axis focusing PBP lens, which may be the on-axis focusing PBP lens 200 or the on-axis focusing PBP lens 250. The side view shows an out-of-plane lens pattern center axis 288 and an out-of-plane geometry center axis 299 passing through the lens pattern center O_{L} and the geometry center O_{G}, respectively. The out-of-plane lens pattern center axis 288 and the out-of-plane geometry center axis 299 may be perpendicular to the surface plane (e.g., the x-y plane). That is, the out-of-plane lens pattern center axis 288 and the out-of-plane geometry center axis 299 may be in the z-axis direction or the thickness direction of the lens. For the on-axis focusing PBP lens, because the lens pattern center O_{L} and the geometry center O_{G} coincide with one another, the out-of-plane lens pattern center axis 288 and the out-of-plane geometry center axis 299 also coincide with one another.

FIG. 3A illustrates an LC alignment pattern in a lens layer of an optically anisotropic film 301 included in an off-axis focusing PBP lens 300 according to an embodiment of the present disclosure. The x-y plane may be a light receiving plane of the optically anisotropic film 301. The off-axis focusing PBP lens 300 may function as a spherical lens. FIG. 3A shows that the off-axis focusing PBP lens 300 has a circular shape. The origin (point “O” in FIG. 3A) of the x-y plane corresponds to a lens pattern center (O_{L}) 310 of the off-axis focusing PBP lens 300. A geometry center (O_{G}) 320 of the lens may be the center of the circular shape of the lens. As shown in FIG. 3A, in the off-axis focusing PBP lens 300, the lens pattern center (O_{L}) 310 is shifted from the geometry center (O_{G}) 320 in a predetermined direction (e.g., the x-axis direction) for a predetermined distance D.

The optically anisotropic film 301 may include one or more birefringent materials including LC molecules 305. An optic axis of the optically anisotropic film 301 may be configured with a continuous in-plane rotation (or rotation pattern) from the lens pattern center (O_{L}) 310 to a lens periphery 315 of the off-axis focusing PBP lens 300 in a plurality of radial directions. That is, the directors of the optically anisotropic molecules included in the optically anisotropic film 301 may continuously rotate along a plurality of radial directions. In other words, the azimuthal angles of the optically anisotropic molecules of the optically anisotropic film 301 may continuously change in a plurality of radial directions. An azimuthal angle changing rate of the optic axis of the optically anisotropic film 301 may increase from the lens pattern center (O_{L}) 310 to the lens periphery 315 of the off-axis focusing PBP lens 300 in the radial directions. The lens pattern center (O_{L}) 310 of the off-axis focusing PBP lens 300 may be a point at which the azimuthal angle changing rate is the smallest. That is, the in-plane rotation of the optic axis of the optically anisotropic film 301 may accelerate from the lens pattern center (O_{L}) 310 to the lens periphery 315 in the radial directions. In some embodiments, the azimuthal angle of the optic axis of the optically anisotropic film 301 may be proportional to the distance from the lens pattern center (O_{L}) 310 (also the origin O of the x-y plane) to the local point in the lens plane.

For example, the azimuthal angle θ of the optic axis of the optically anisotropic film 301 in the off-axis focusing PBP lens 300 functioning as a spherical lens may change approximately according to an equation of

$$θ = \frac{Γ}{2} = \frac{π {r}^{2}}{2 L λ} ,$$

where θ is the azimuthal angle of the optic axis at a local point of the optically anisotropic film 301, r is a distance from the lens pattern center (O_{L}) 310 (also the origin θ of the x-y plane) to the local point on the optic axis, L is a distance between a lens plane and a focal plane of the off-axis focusing PBP lens 300, and λ is a wavelength of a light incident onto the off-axis focusing PBP lens 300, is a phase shift experienced by a light incident onto the lens with a wavelength λ. The azimuthal angle changing rate (that is a changing rate of θ or a rotational velocity of θ) is a derivative

$$\frac{d θ}{d r} = \frac{π}{L λ} r ,$$

which is zero when r=0. Thus, the point at which r=0 may be a point with the smallest rotation rate of θ or the smallest azimuthal angle changing rate.

In some embodiments, the optically anisotropic film 301 may include calamitic (rod-like) LC molecules 305. The directors of the LC molecules 305 (LC directors) may continuously rotate in a surface plane (e.g., the x-y plane) in a continuous in-plane rotation pattern. As a result, the optic axis of the optically anisotropic film 301 may have a continuous in-plane rotation (or rotation pattern). As shown in FIG. 3A, the off-axis focusing PBP lens 300 may be a half-wave retarder (or half-wave plate) configured with a lens profile based on an alignment pattern of the LC molecules 305 in the surface plane (e.g., alignment pattern of the LC molecules 305 in the x-y plane shown in FIG. 3A). An azimuthal angle (θ) characterizing the alignment of LC directors may continuously vary from the lens pattern center (O_{L}) 310 to a lens periphery 315 of the off-axis focusing PBP lens 300, with a varying pitch A. The continuous in-plane rotation of the LC directors refers to the continuous variation or change of the azimuthal angle (θ) of the LC molecules 305 in the x-y plane. As shown in FIG. 3A, the lens pattern center (O_{L}) 310 of the off-axis focusing PBP lens 300 may not coincide with the geometry center (O_{G}) 320. Instead, the lens pattern center (O_{L}) 310 of the off-axis focusing PBP lens 300 may be shifted by a predetermined distance D in a predetermined direction from the geometry center (O_{G}) 320. The shifting direction and the distance D of the shift may be determined based on a desirable position of a focus (focal point) at a focal plane of the off-axis focusing PBP lens 300. That is, the deviation of the focus of the off-axis focusing PBP lens 300 may be determined by the shifting direction and the distance D of the shift. The entire lens pattern of the off-axis focusing PBP lens 300 may be rotationally centrally asymmetric with respect to either one of the lens pattern center (O_{L}) 310 or the geometry center (O_{G}) 320. A predetermined portion of the entire lens pattern (e.g., less than the entire lens pattern) of the off-axis focusing PBP lens 300 may be rotationally centrally symmetric with respect to the lens pattern center (O_{L}) 310. FIG. 3A shows that the lens pattern center (O_{L}) 310 of the off-axis focusing PBP lens 300 is shifted by a distance D in the +x direction from the geometry center (O_{G}) 320 of the off-axis focusing PBP lens 300. This shift is for illustrative purposes and is not intended to limit to the scope of the present disclosure. The shift may be in any other suitable directions and for any other suitable distances. For example, in some embodiments, the lens pattern center (O_{L}) 310 may be shifted by a predetermined distance in the −x-axis direction from the geometry center (O_{G}) 320. In some embodiments, the predetermined direction may be other directions.

FIG. 3B illustrates a section of an LC director field taken along an x-axis in the off-axis focusing PBP lens 300 shown in FIG. 3A. As shown in FIG. 3B, according to the LC director field along the x-axis, the pitch may be a function of a distance from the lens pattern center (O_{L}) 310. Because the lens pattern center (O_{L}) 310 does not coincide with the geometry center (O_{G}) 320, the pitch may be expressed as a function of the distance from the lens pattern center (O_{L}) 310 of the off-axis focusing PBP lens 300 in the radial directions from the origin O (located at the lens pattern center O_{L}). As shown in FIG. 3B, the pitch may monotonically decrease as the distance from the lens pattern center (O_{L}) 310 increases in the radial direction (e.g., the x-axis direction). For example, the pitch in a central region including the lens pattern center (O_{L}) 310 may be Λ₀, which may be the largest. The pitch in first edge region at a first edge 315R (e.g., a right edge in FIG. 3B) may be Λ₁, which may be smaller than Λ₀. The pitch at a second edge region including a second edge 315L (e.g., a left edge in FIG. 3B) may be Λᵣ, which may be the smallest, i.e., Λ₀>Λ₁> . . . >Λᵣ.

In some embodiments, the origin (point “O” in FIG. 3A) of the x-y plane may be configured at the geometry center (O_{G}) 320 of the off-axis focusing PBP lens 300 instead of at the lens pattern center (O_{L}) 310. When the off-axis focusing PBP lens 300 provides a parabolic phase profile, and when the lens pattern center (O_{L}) 310 is shifted with respect to the geometry center (O_{G}) 320 of the off-axis focusing PBP lens 300 along the x-axis, a phase shift experienced by a light with a wavelength λ incident onto the off-axis focusing PBP lens 300 may be expressed as

$$Γ \approx \frac{π {r}^{2}}{L λ} - \frac{2 π}{λ} K * x ,$$

where K is a non-zero coefficient, r is a distance from the lens pattern center (O_{L}) 310 of the off-axis focusing PBP lens 300 to a local point of the off-axis focusing PBP lens 300, L is a distance between a lens plane and a focal plane of the of the off-axis focusing PBP lens 300, and x is a coordinate in the predetermined direction of the predetermined shift of the lens pattern center (O_{L}) 310 with respect to the geometry center (O_{G}). The corresponding equation for the azimuthal angle θ is

$$θ = \frac{Γ}{2} \approx \frac{π {r}^{2}}{2 L λ} - \frac{π}{λ} K * x .$$

The first term

$$\frac{π {r}^{2}}{2 L λ}$$

corresponds to an optical power of the off-axis focusing PBP lens 300, and the second term corresponds to a shift of the lens pattern center (O_{L}) 310 with respect to the geometry center (O_{G}). The azimuthal angle changing rate in a shifting direction (e.g., an x-axis direction, r=x) may be calculated according to

$$\frac{d θ}{d x} = \frac{π}{λ} * ( \frac{x}{L} - K ) .$$

The azimuthal angle changing rate may be the smallest at a point x_{c}=D=KL when

$$\frac{d θ}{d x} = 0 .$$

A phase shift experienced by the light with the wavelength λ incident onto an on-axis focusing PBP lens corresponding to the off-axis focusing PBP lens 300 may be expressed as

$$Γ \approx \frac{π {r}^{2}}{L λ} .$$

The off-axis focusing PBP lens 300 may be a PBP grating with a varying periodicity in the opposite radial directions, from the lens pattern center (O_{L}) 310 to the opposite lens peripheries 315. A period P of the lens pattern of the off-axis focusing PBP lens 300 may be defined as a distance over which the azimuthal angle θ of the optic axis of the optically anisotropic film 301 changes by π in the radial directions. Fringes of the PBP grating over the entire PBP grating may not have a central symmetry about the lens pattern center (O_{L}) 310. Fringes of the PBP grating in a predetermined region of the entire PBP grating including the lens pattern center (O_{L}) 310 may have a central symmetry with respect to the lens pattern center center (O_{L}) 310. A fringe of the PBP grating (i.e., the off-axis focusing PBP lens 300) refers to a set of local points at which the azimuthal angle of the optic axis (or the rotation angle of the optic axis starting from the lens pattern center (O_{L}) 310 to the local point in the radial direction) is the same. For example, when the rotation angle of the optic axis starting from the lens pattern center (O_{L}) 310 to the local point in the radial direction is expressed as θ=θ₁+nπ (0<θ₁<π), both θ₁ and n may be the same for the local points on the same fringe. A difference in the rotation angles of the neighboring fringes is π, i.e., the distance between the neighboring fringes is a period P. The set of local points may be on the same circle for an off-axis focusing PBP lens functioning as a spherical lens or an aspherical lens.

In some embodiments, when the azimuthal angle θ of the optic axis changes approximately according to the equation

$$θ = \frac{π {r}^{2}}{2 L λ} ,$$

the period P of the lens pattern may change approximately according to an equation

$$P \approx \frac{L λ}{2} * \frac{1}{r} .$$

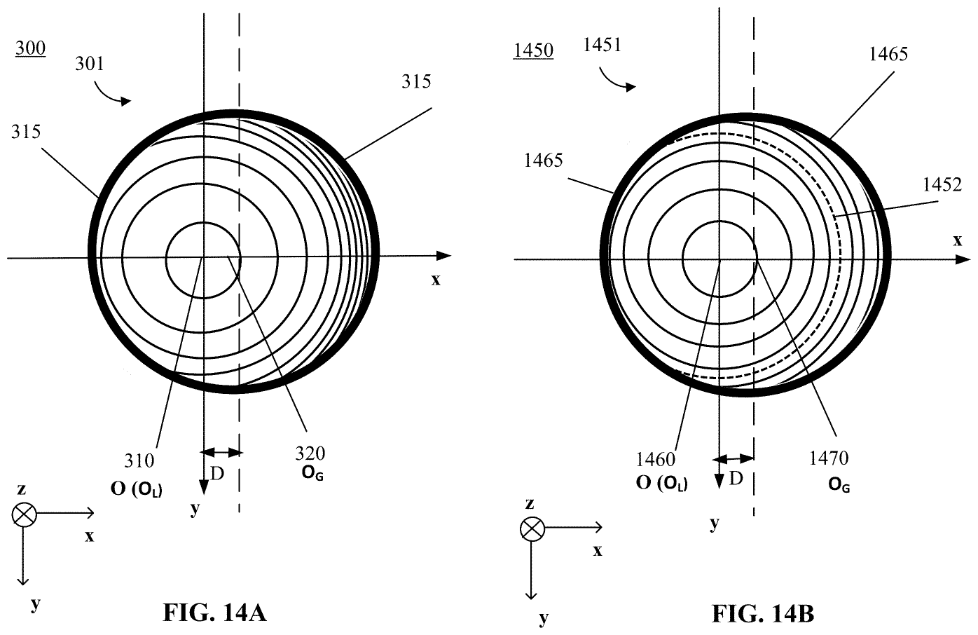

The period P may be roughly inversely proportional to the distance r from the lens pattern center (O_{L}) 310 to the local point on the optic axis, when the distance r from the lens pattern center (O_{L}) 310 is much larger than the period P of the lens pattern (r>>P). In some embodiments, the period P of the lens pattern of the off-axis focusing PBP lens 300 may monotonically change (e.g., monotonically decrease) in the entire off-axis focusing PBP lens from the lens pattern center (O_{L}) 310 in the opposite radial directions, i.e., from the lens pattern center (O_{L}) 310 to the opposite lens peripheries 315. Accordingly, the off-axis focusing PBP lens 300 may function as a spherical PBP lens. FIG. 14A illustrates configuration of fringes and a varying periodicity of the off-axis focusing PBP spherical lens 300 shown in FIGS. 3A and 3B, according to an embodiment of the present disclosure. FIG. 14A illustrates an x-y sectional view of the lens layer of the optically anisotropic film 301 of the off-axis focusing PBP spherical lens 300 shown in FIGS. 3A and 3B, and does not show the LC molecules. Circles or arcs in FIG. 14A represent grating fringes. Local points of the optic axis on the same grating fringe may have the same azimuthal angle θ (or rotation angle). Local points of the optic axis on two adjacent grating fringes may have a change of it in the azimuthal angle θ. Thus, a difference between the radii of two adjacent grating fringes may represent the period P of the lens pattern of the off-axis focusing PBP lens 300. As shown in FIG. 14A, the period P of the lens pattern of the off-axis focusing PBP spherical lens 300 may monotonically change (e.g., monotonically decrease) in the entire off-axis focusing PBP lens 300 from the lens pattern center (O_{L}) 310 in the opposite radial directions, i.e., from the lens pattern center (O_{L}) 310 to the opposite lens peripheries 315.

In some embodiments, the period P of the lens pattern of an off-axis focusing PBP lens may not monotonically change (e.g., may not monotonically decrease) in the opposite radial directions from a lens pattern center (O_{L}) to opposite lens peripheries. Instead, the period P of the lens pattern of the off-axis focusing PBP lens may monotonically change (e.g., monotonically decrease) only in a portion of the lens including the lens pattern center (O_{L}) (less than the entire lens), in the opposite radial directions from a lens pattern center (O_{L}) to opposite lens peripheries. Accordingly, the off-axis focusing PBP lens may function as an aspherical PBP lens (referred to as an off-axis focusing PBP aspherical lens). For example, the period P of the lens pattern of the off-axis focusing PBP aspherical lens may first decrease then increase in the radial directions from the lens pattern center (O_{L}) to the lens periphery. The lens pattern center (O_{L}) of the off-axis focusing PBP aspherical lens may not correspond to a geometry center of the off-axis focusing PBP aspherical lens.

FIG. 14B illustrates configuration of fringes and a varying periodicity of an off-axis focusing PBP aspherical lens 1450, according to an embodiment of the present disclosure. FIG. 14B illustrates an x-y sectional view of a lens layer of an optically anisotropic film 1451 of the off-axis focusing PBP spherical lens 1450, and does not show the LC molecules. Circles or arcs in FIG. 14A represent grating fringes. Local points of the optic axis on the same grating fringe may have the same azimuthal angle θ. Local points of the optic axis on two adjacent grating fringes may have a change of π in the azimuthal angle θ. Thus, a difference between the radii of two adjacent grating fringes may represent the period P of the lens pattern of the off-axis focusing PBP aspherical lens 1450. As shown in FIG. 14B, the period P of the lens pattern of the off-axis focusing PBP aspherical lens 1450 may not monotonically change (e.g., monotonically decrease) in the entire lens in the opposite radial directions from a lens pattern center (O_{L}) 1460 to opposite lens peripheries 1465. Instead, the period P of the lens pattern of the off-axis focusing PBP aspherical lens 1450 may first decrease then increase in the radial directions. For illustrate purposes, FIG. 14B shows the period P of the lens pattern of the off-axis focusing PBP aspherical lens 1450 may monotonically decrease only in a portion of the lens including lens pattern center (O_{L}) 1460 in the opposite radial directions, for example, within an area of the lens enclosed by a grating fringe 1452. Outside the area of the lens enclosed by a grating fringe 1452, the period P of the lens pattern of the off-axis focusing PBP aspherical lens 1450 may monotonically increase in the opposite radial directions. Although not shown, in some embodiments, the period P of the lens pattern of the off-axis focusing PBP aspherical lens 1450 may first decrease, then increase, then decrease again, and so on, in the opposite radial directions.

FIG. 3C illustrates an LC alignment pattern in a lens layer of an optically anisotropic film 351 included in an off-axis focusing PBP lens 350 functioning as an off-axis focusing cylindrical lens. The optically anisotropic film 351 may include one or more birefringent materials including LC molecules (small molecules) or mesogenic fragments (LC polymers) 355. The off-axis focusing PBP lens 350 may have a rectangular shape (or a rectangular lens aperture). The origin (point “O” in FIG. 3C) of the x-y plane may correspond to a lens pattern center (O_{L}) 360. A geometry center (O_{G}) 370 may be the center of the rectangular lens shape of the off-axis focusing PBP lens 350. As shown in FIG. 3C, the lens pattern center (O_{L}) 360 may be shifted from the geometry center (O_{G}) 370 for a predetermined distance D (or a shift D) in a predetermined in-plane direction (e.g., the x-axis direction). The lens pattern center (O_{L}) 360 and the geometry center (O_{G}) 370 of the off-axis focusing PBP lens 350 may be located on a same symmetric axis (e.g., the lateral symmetric axis) of the aperture of the off-axis focusing PBP lens 350 (e.g., the x-axis).

For the off-axis focusing PBP lens 350 having a rectangular shape (or a rectangular lens aperture), a width direction of the off-axis focusing PBP lens 350 may be referred to as a lateral direction (e.g., an x-axis direction in FIG. 3C), and a length direction of the off-axis focusing PBP lens 350 may be referred to as a longitudinal direction (e.g., a y-axis direction in FIG. 3C). An in-plane lens pattern center axis 363 may be an axis parallel with the longitudinal direction and passing through the lens pattern center (O_{L}) 360. An in-plane geometry center axis 373 may be an axis parallel with the longitudinal direction and passing through the geometry center (O_{G}) 370. The in-plane lens pattern center axis 363 and the in-plane geometry center axis 373 are parallel with one another and separated from one another with the predetermined distance D in the predetermined direction.

An optic axis of the optically anisotropic film 351 may be configured with a continuous in-plane rotation from the lens pattern center (O_{L}) 360 to a lens periphery 365 of the off-axis focusing PBP lens 350 in the lateral direction. An azimuthal angle changing rate of the optic axis of the optically anisotropic film 351 may increase from the lens pattern center (O_{L}) 360 to the lens periphery 365 of the off-axis focusing PBP lens 350 in the lateral direction. That is, the continuous in-plane rotation of the optic axis of the optically anisotropic film 351 of the off-axis focusing PBP lens 350 may accelerate from the lens pattern center (O_{L}) 360 to the lens periphery 365 in the lateral direction. The azimuthal angles of the optic axis at locations on the same side of the in-plane lens pattern center axis 363 and having a same distance from the in-plane lens pattern center axis 363 in the lateral direction may be substantially the same.

In some embodiments, the optically anisotropic film 351 may include calamitic (rod-like) LC molecules 355. The directors of the molecules 355 (or LC directors) may continuously rotate in a predetermined in-plane direction in the surface plane of the optically anisotropic film 351. The in-plane continuous rotation of the directors of the molecules 355 may result in a continuous in-plane rotation (or rotation pattern) of the optic axis of the optically anisotropic film 351. As shown in FIG. 3C, the off-axis focusing PBP lens 300 may be a half-wave retarder (or half-wave plate) with LC molecules 355 arranged in a modulated in-plane alignment pattern, which may create a lens profile. Directors of the LC molecules 355 (or azimuthal angles (θ) of the LC molecules 355) may be configured with a continuous in-plane rotation with a varying pitch (Λ₀, Λ₁, . . . , Λᵣ) from the lens pattern center (O_{L}) 360 to the lens periphery 365 in the lateral direction (e.g., an x-axis direction in FIG. 3C). The orientations of the directors of the LC molecules 355 (the LC directors) located on the same side of the in-plane lens pattern center axis 363 and at a same distance from the in-plane lens pattern center axis 363 may be substantially the same. As shown in FIG. 3C, the pitch of the lens pattern (or the optic axis pattern) may be a function of the distance from the in-plane lens pattern center axis 363 in the lateral direction. The pitch of the lens pattern may monotonically decrease as the distance from the in-plane lens pattern center axis 363 in the lateral direction (e.g., the x-axis direction) increases. For example, the pitch at the region labelled by a dashed rectangle 367 including the lens pattern center (O_{L}) 360 may be Λ₀, which may be the largest. The pitch at a region including the lens periphery 365 (e.g., a right lens periphery in FIG. 3C) may be Λ₁, which may be smaller than Λ₀. The pitch at a region including the lens periphery 365 (e.g., a left lens periphery in FIG. 3C) may be Λᵣ, which may be the smallest, i.e., Λ₀>Λ₁> . . . >Λᵣ.

In the optically anisotropic film 351 shown in FIG. 3C, the lens pattern center (O_{L}) 360 of the off-axis focusing PBP lens 350 may not coincide with the geometry center (O_{G}) 370. Instead, the lens pattern center (O_{L}) 360 of the off-axis focusing PBP lens 350 may be shifted by a predetermined distance D in a predetermined direction from the geometry center (O_{G}) 370 of the off-axis focusing PBP lens 350. Accordingly, the in-plane lens pattern center axis 363 of the off-axis focusing PBP lens 350 may not coincide with the in-plane geometry center axis 373 of the off-axis focusing PBP lens 350. Instead, the in-plane lens pattern center axis 363 of the off-axis focusing PBP lens 350 may be shifted by a predetermined distance D in a predetermined direction from the in-plane geometry center axis 373 of the off-axis focusing PBP lens 350. The shifting direction and the distance D of the shift may be determined based on a desirable position of a focal line at a focal plane of the off-axis focusing PBP lens 350. That is, the deviation of the focal line of the off-axis focusing PBP lens 350 may be determined by the shifting direction and the distance D of the shift. In the embodiment shown in FIG. 3C, the lens pattern center (O_{L}) 360 of the off-axis focusing PBP lens 300 is shifted by a distance D in the +x direction from the geometry center (O_{G}) 370 of the off-axis focusing PBP lens 350. Accordingly, the in-plane lens pattern center axis 363 of the off-axis focusing PBP lens 300 is shifted by a distance D in the +x direction from the in-plane geometry center axis 373 of the off-axis focusing PBP lens 350. This shift is for illustrative purposes and is not intended to limit to the scope of the present disclosure. The shift may be in any other suitable directions and for any other suitable distances. For example, in some embodiments, the lens pattern center (O_{L}) 360 may be shifted by a predetermined distance in the −x-axis direction from the geometry center (O_{G}) 370. In some embodiments, the predetermined direction may be other directions.

The off-axis focusing PBP lens 350 may be a PBP grating with a varying periodicity in the opposite lateral directions from the in-plane lens pattern center axis 363 to the opposite lens periphery 365. A period P of the lens pattern of the off-axis focusing PBP lens 350 may be defined as a distance over which the azimuthal angle θ of the optic axis of the optically anisotropic film 351 changes by π in the lateral directions. Fringes of the PBP grating over the entire PBP grating may not have an axial symmetry about the in-plane lens pattern center axis 363. Fringes of the PBP grating in a predetermined region of the entire PBP grating may have a central symmetry about the lens pattern center (O_{L}) 360. A fringe of the PBP grating refers to a set of local points at which the azimuthal angle of the optic axis (or the rotation angle of the optic axis starting from the in-plane lens pattern center axis 363 to the local point in the lateral direction) is the same. For example, when the rotation angle of the optic axis from the in-plane lens pattern center axis 363 to the local point in the lateral direction is expressed θ=θ₁+nπ (0<θ₁<π), both θ₁ and n may be the same for the local points on the same fringe. A difference in the rotation angles of the neighboring fringes is it, i.e., the distance between the neighboring fringes is the period P. The set of local points may be on the same line parallel to the longitudinal direction for an off-axis focusing PBP lens functioning as cylindrical lens.

FIG. 3D illustrates a side view of an off-axis focusing PBP lens, which may be the off-axis focusing PBP lens 300 or 350. The side view shows an out-of-plane lens pattern center axis 388 and an out-of-plane geometry center axis 399 passing through the lens pattern center (O_{L}) 360 and the geometry center (O_{G}) 370, respectively. The out-of-plane lens pattern center axis 388 and the out-of-plane geometry center axis 399 may be perpendicular to the surface plane (e.g., the x-y plane). That is, the out-of-plane lens pattern center axis 388 and the out-of-plane geometry center axis 399 may be in the z-axis direction or the thickness direction of the lens. For the off-axis focusing PBP lens, the lens pattern center (O_{L}) 360 is shifted from the geometry center (O_{G}) 370 for a predetermined distance D. The shift may also correspond to the shift or distance between the parallel out-of-plane lens pattern center axis 388 and the out-of-plane geometry center axis 399.

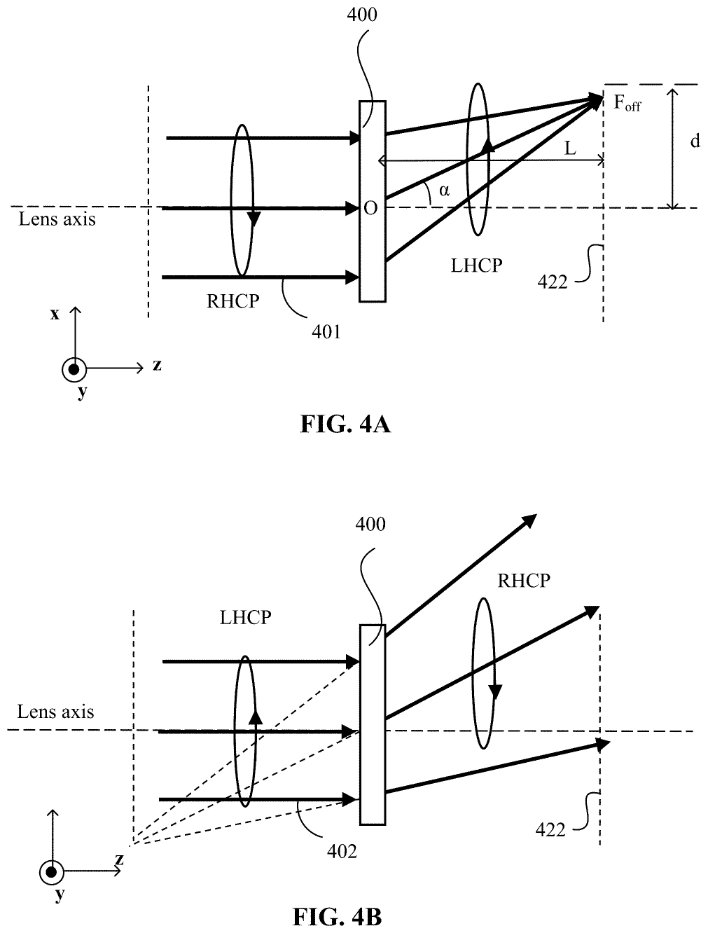

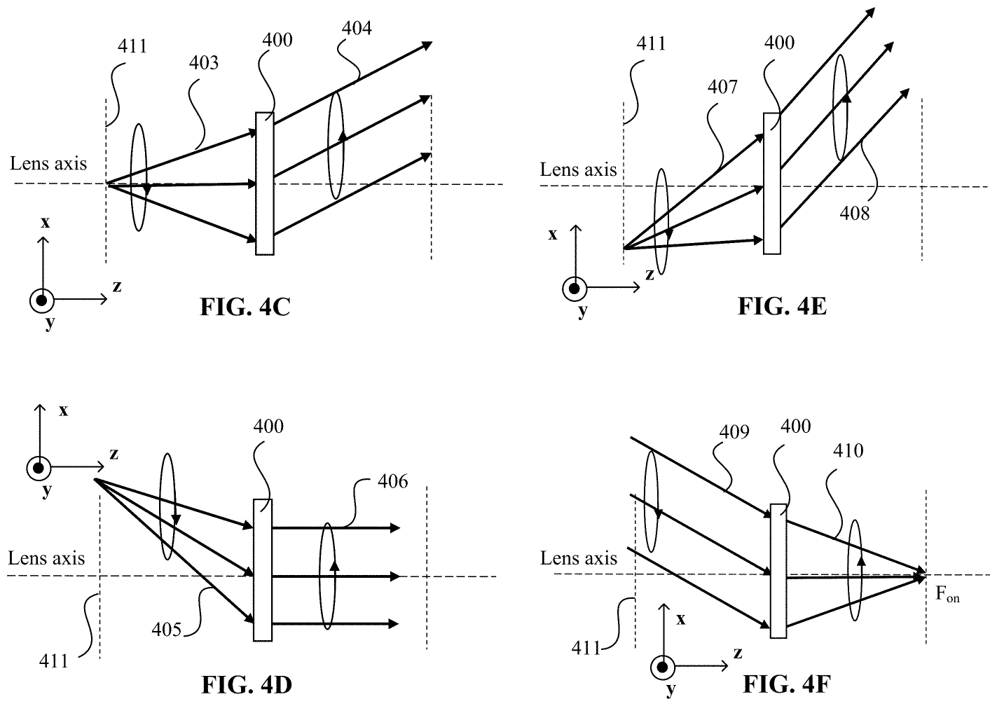

FIGS. 4A-4F illustrate deflections of lights by an off-axis focusing PBP lens 400, according to various embodiments of the present disclosure. The off-axis focusing PBP lens 400 may be an embodiment of the off-axis focusing PBP lenses shown in FIGS. 1A-1D, and FIGS. 3A-3D. The off-axis focusing PBP lens 400 may be an active off-axis focusing PBP lens or a passive off-axis focusing PBP lens. The optically anisotropic film of a passive off-axis focusing PBP lens may include polymerized RMs, LC polymers, or amorphous polymers with an photo-induced alignment, which may not be reorientable by an external field, e.g., an electric field. The optically anisotropic film of an active off-axis focusing PBP lens may include active LCs, which may be reorientable by an external field, e.g., an electric field. The phase retardation of the off-axis focusing PBP lens 400 may be a half wave or an odd number of half waves.

The off-axis focusing PBP lens 400 may be configured to operate in a focusing state for a circularly polarized light having a predetermined handedness (e.g., left handedness or right handedness). For example, as shown in FIG. 4A, the off-axis focusing PBP lens 400 may operate in a focusing state (or a converging state) for a right-handed circularly polarized (“RHCP”) incident light. For example, the off-axis focusing PBP lens 400 may focus an on-axis collimated RHCP light 401 to an off-axis focal point (or focus) F_{off}. The off-axis focal point F_{off} may be shifted from the out-of-plane geometry center axis (or the lens axis) by a distance din a predetermined direction, for example, in the +x-axis direction. The focus shift d in a focal plane 422 may be expressed as d=L*tan(α), where α is an angle formed by a line connecting the off-axis focal point F_{off} and a geometric center O of the lens aperture relative to the out-of-plane geometry center axis (e.g., z-axis in FIG. 4A), and L is the distance between the lens plane of in the off-axis focusing PBP lens 400 and the focal plane 422 of the off-axis focusing PBP lens 400.

As shown in FIG. 4B, the off-axis focusing PBP lens 400 may operate in a defocusing state (or a diverging state) for an LHCP incident light. For example, the off-axis focusing PBP lens 400 may defocus (or diverge) an on-axis collimated LHCP light 402. Thus, the off-axis focusing PBP lens 400 may be indirectly switched between operating in a focusing state and operating in a defocusing state by switching the handedness of the incident light. The embodiments shown in FIG. 4A and FIG. 4B are for illustrative purposes. In some embodiments, the off-axis focusing PBP lens 400 may be configured to operate in a focusing state for an LHCP incident light and operate in a defocusing state for an RHCP incident light.

As shown in FIGS. 4A and 4B, the off-axis focusing PBP lens 400 may reverse the handedness of a circularly polarized light passing therethrough in addition to focusing or defocusing (or converging/diverging) the circularly polarized incident light. In some embodiments, when the off-axis focusing PBP lens 400 is flipped such that an light incidence side and a light exiting side are flipped, the focusing state and the defocusing state of the off-axis focusing PBP lens 400 may be reversed for the circularly polarized incident light with the same handedness. For example, after the flip, the off-axis focusing PBP lens 400 may operate in a focusing state for an LHCP incident light, and operate in a defocusing state for an RHCP incident light. For example, the off-axis focusing PBP lens 400 may focus the on-axis collimated LHCP light 402 to an off-axis focal point, and may defocus the on-axis collimated RHCP light 401.

In addition to focusing or defocusing an on-axis collimated light, the off-axis focusing PBP lens 400 may also have other features. FIG. 4C shows that the off-axis focusing PBP lens 400 may convert an on-axis diverging light 403 emitted from a point light source located in a focal plane 411 to an off-axis collimated light 404. FIG. 4D shows that the off-axis focusing PBP lens 400 may convert an off-axis diverging light 405 emitted from a point light source, which may be located in the focal plane 411 and disposed at an off-axis location relative to the out-of-plane geometry center axis of the off-axis focusing PBP lens 400, to an on-axis collimate light 406. FIG. 4E shows that the off-axis focusing PBP lens 400 may convert an off-axis diverging light 407 from a point light source, which may be located in the focal plane 411 and disposed at an off-axis location relative to the out-of-plane geometry center axis of the off-axis focusing PBP lens 400, to an off-axis collimated light 408. As shown in FIGS. 4C-4E, a displacement of the point light source in the focal plane 411 from the out-of-plane geometry center axis may change the deflection angle of collimated light 408 after propagating through the off-axis focusing PBP lens 400. FIG. 4F shows that the off-axis focusing PBP lens 400 may focus an off-axis collimated light 409 as a converging light 410, which converses to an on-axis focal point Fₒₙ.

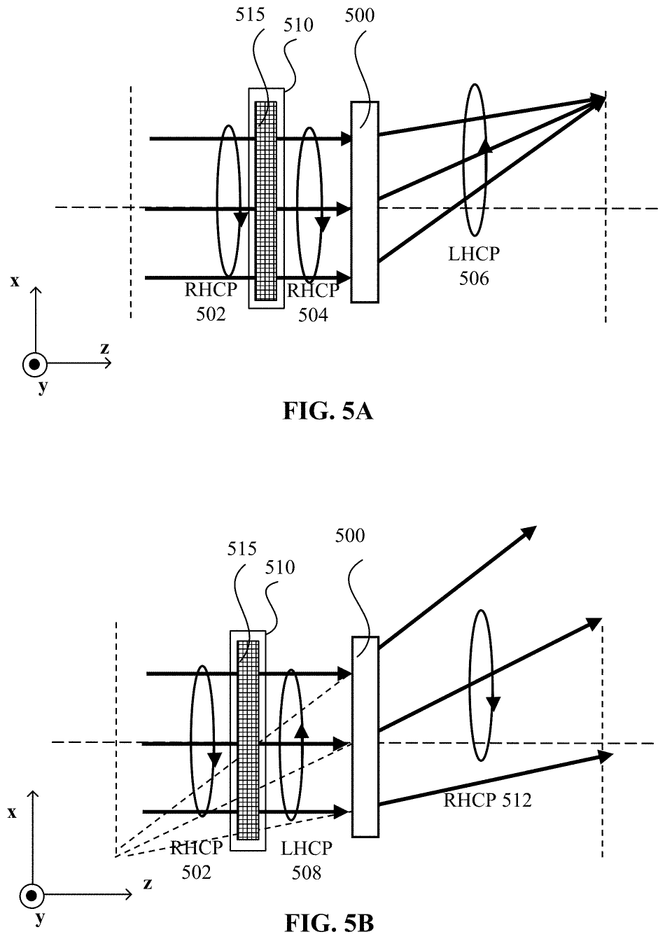

The off-axis focusing PBP lens in accordance with an embodiment of the present disclosure may be indirectly switchable between a focusing state and a defocusing state via changing a handedness of an incident light of the off-axis focusing PBP lens through an external polarization switch. FIGS. 5A and 5B illustrate an indirect switching of an off-axis focusing PBP lens 500 between a focusing state and a defocusing state, according to an embodiment of the present disclosure. The off-axis focusing PBP lens 500 may be an embodiment of the off-axis focusing PBP lenses shown in FIGS. 1A-1D, and FIGS. 3A-4F. The off-axis focusing PBP lens 500 may be an active off-axis focusing PBP lens (e.g., fabricated based on active LCs) or a passive off-axis focusing PBP lens (e.g., fabricated based on non-active LCs, for example, reactive mesogen (“RM”)). As shown in FIGS. 5A and 5B, the off-axis focusing PBP lens 500 may be switchable between a focusing state and a defocusing state via changing the handedness of an incident light of the off-axis focusing PBP lens 500 through a polarization switch 510. The polarization switch 510 may be optically coupled with the off-axis focusing PBP lens 500, and may be configured to control the handedness of a circularly polarized light before the circularly polarized light is incident onto the off-axis focusing PBP lens 500. The polarization switch 510 may be any suitable polarization rotator. In some embodiments, the polarization switch 510 may include a switchable half-wave plate (“SHWP”) 515 configured to transmit a circularly polarized light at an operating state (e.g., a switching state or a non-switching state). The SHWP 515 operating at the switching state may reverse the handedness of the circularly polarized incident light, and the SHWP 515 operating at the non-switching state may transmit the circularly polarized incident light without affecting the handedness.

In some embodiments, the off-axis focusing PBP lens 500 may operate in a focusing state for an RHCP incident light, and may operate in a defocusing state for an LHCP incident light. Thus, the SHWP 515 may be configured to control an optical state (focusing or defocusing state) of the off-axis focusing PBP lens 500 by controlling the handedness of the circularly polarized light incident onto the off-axis focusing PBP lens 500. In some embodiments, the SHWP 515 may include an LC layer. The operating state (switching or non-switching state) of the SHWP 515 may be controllable by controlling an external electric field applied to LC layer.

As shown in FIG. 5A, the SHWP 515 operating at the non-switching state may transmit an RHCP light 502 without affecting the handedness, and output an RHCP light 504 toward the off-axis focusing PBP lens 500. Accordingly, the off-axis focusing PBP lens 500 may operate in a focusing state for the RHCP light 504, and output a converging LHCP light 506. When the RHCP light 504 is an on-axis collimated RHCP light, the RHCP light 504 may be focused to an off-axis focal point by the off-axis focusing PBP lens 500. As shown in FIG. 5B, the SHWP 515 operating at the switching state may reverse the handedness of a circularly polarized incident light. Thus, an on-axis collimated RHCP light 502 incident onto the SHWP 515 may be transmitted as an on-axis collimated LHCP light 508. The off-axis focusing PBP lens 500 may operate in a defocusing state for the on-axis collimated LHCP light 508, and may output a diverging RHCP light 512.

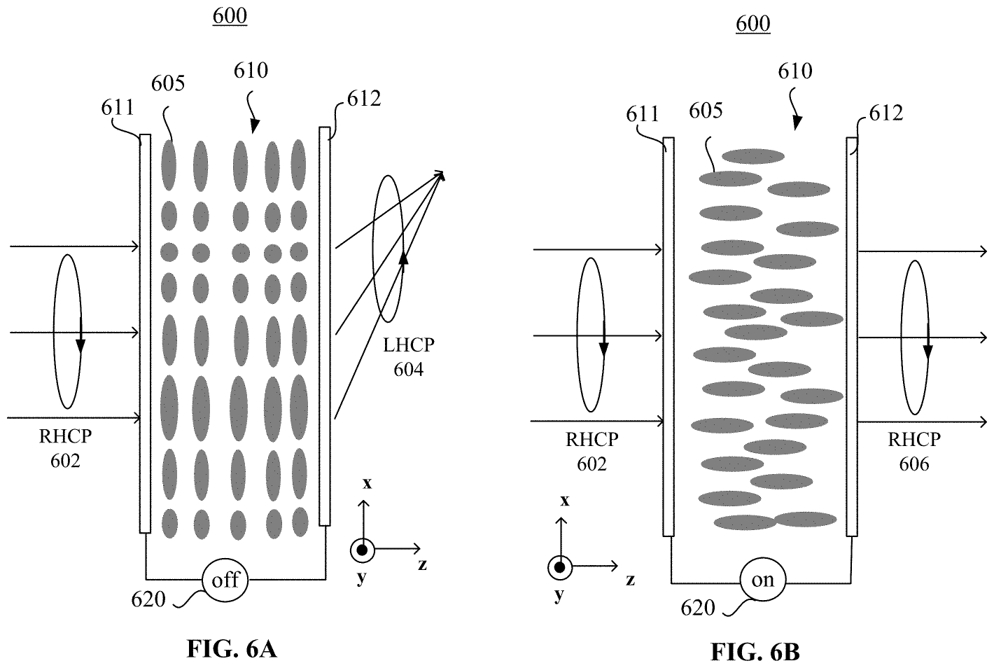

As described above, an off-axis focusing PBP lens may operate in a focusing or a defocusing state depending on the handedness of the circularly polarized light incident onto the off-axis focusing PBP lens and the handedness of the rotation of the LC directors in the off-axis focusing PBP lens. In some embodiments, an active off-axis focusing PBP lens may be switched between a focusing state (or a defocusing state), in which a positive (or a negative) optical power is provided to the incident light, and a neutral state, in which substantially zero optical power is provided to the incident light. For discussion purposes, FIGS. 6A and 6B illustrate a switching of an active off-axis focusing PBP lens 600 between a focusing state and a neutral state. Although the switch between the defocusing state and the neutral state is not shown, it is understood that the defocusing state may be realized in FIG. 6A when the handedness of the incident light of the off-axis focusing PBP lens 600 is switched to an opposite handedness.

As shown in FIGS. 6A and 6B, the active off-axis focusing PBP lens 600 may have an optically anisotropic film 610 including active nematic LCs. The active off-axis focusing PBP lens 600 may include two substrates 611 and 612 disposed on two sides of the optically anisotropic film 610. The substrates 611 and 612 may each include an electrode (not shown). At least one of the substrates 611 and 612 may be provided with a PAM layer that is in-plane patterned to provide a lens pattern (not shown). An embodiment of the configuration of the electrodes is shown in FIG. 1C. A power source 620 may be electrically coupled with the electrodes included in the substrates 611 and 612 to supply a voltage across the optically anisotropic film 610, thereby generating a vertical electric field (e.g., in the z-axis) perpendicular to the substrates 611 and 612.

At a voltage-off state, as shown in FIG. 6A, LC molecules 605 in the optically anisotropic film 610 may be aligned in a patterned LC alignment to provide an optical power to (i.e., to focus or defocus) an incident light. In the example shown in FIG. 6A, the active off-axis focusing PBP lens 600 may operate in a focusing state for an RHCP light 602, and may converge the RHCP light bam 602 as an LHCP light 604. For example, when the RHCP light 602 is an on-axis collimated RHCP light, the active off-axis focusing PBP lens 600 may focus the on-axis collimated RHCP light to an off-axis focal point.

At a voltage-on state, as shown in FIG. 6B, the vertical electric field (e.g., the electric field in the z-axis) perpendicular to the substrates 611 and 612 may be generated in the optically anisotropic film 610 via a voltage applied to electrodes separately disposed at the first and second substrates 611 and 612. The LC molecules 605 may be reoriented along the direction of the vertical electric field (e.g., z-axis). For discussion purposes, FIGS. 6A and 6B show that the active nematic LCs have a positive dielectric anisotropy. The LC molecules 605 may trend to be perpendicular to the substrates 611 and 612 when the vertical electric field is sufficiently strong. That is, the LC molecules 605 may be reoriented to be in a homeotropic state. Thus, the optically anisotropic film 610 may operate as an optically isotropic medium for an incoming light. Accordingly, the active off-axis focusing PBP lens 600 may operate in a neutral state and may negligibly affect or not affect the propagation direction, the wavefront, and the polarization handedness of the incoming light. That is, for a circularly polarized incident light, the active off-axis focusing PBP lens 600 may output a circularly polarized light with substantially the same propagation direction, wavefront, and polarization handedness. For example, as shown in FIG. 6B, the on-axis collimated RHCP light 602 incident onto the active off-axis focusing PBP lens 600 operating in the neutral state may be output as a substantially identical on-axis collimated RHCP light 606. That is, the LC molecules 605 in the optically anisotropic film 610 may be out-of-plane rotated (by the electric field) to switch off the optical power of the active off-axis focusing PBP lens 600. Here, the “out-of-plane” rotation refers to a rotation of the LC directors in a plane perpendicular to a surface of the optically anisotropic film 610 (or perpendicular to the substrates 611, 612). In the example shown in FIG. 6B, the out-of-plane refers to the x-z plane, which is perpendicular to the x-y plane shown in FIGS. 3A-3D.

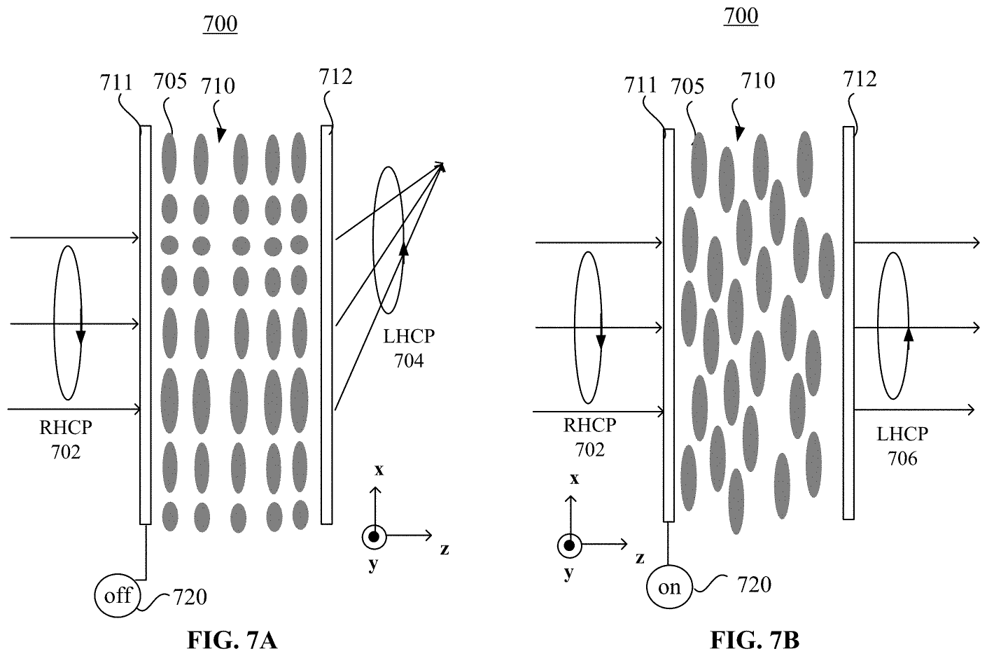

In some embodiments, an active off-axis focusing PBP lens operating at a neutral state with a substantially zero optical power may also affect the handedness of the transmitted light. FIGS. 7A and 7B illustrate a switching of an active off-axis focusing PBP lens 700 between a focusing state with a positive optical power and a neutral state with a substantially zero optical power, according to another embodiment of the present disclosure. Although the switching between the defocusing state and the neutral state is not shown, it is understood that the defocusing state may be realized when the handedness of an incident light of the active off-axis focusing PBP lens 700 is switched to an opposite handedness.

As shown in FIGS. 7A and 7B, the active off-axis focusing PBP lens 700 may have an optically anisotropic film 710 including active nematic LCs. The active off-axis focusing PBP lens 700 may include first and second substrates 711 and 712 disposed on two sides of the optically anisotropic film 710. Electrodes (not shown) may be disposed at one of the first and second substrates 711 and 712. At least one of the substrates 711 and 712 may be provided with a PAM layer that is in-plane patterned to provide a lens pattern (not shown). For illustrative purposes, the electrodes are presumed to be disposed at the first substrate 711. An embodiment of the configuration of the electrodes disposed at one substrate is shown in FIG. 1D. A power source 720 may be electrically coupled with the first substrate 711 to supply a voltage to generate horizontal electric field in the x-axis direction of optically anisotropic film 710.

At a voltage-off state, as shown in FIG. 7A, LC molecules 705 in the optically anisotropic film 710 may be aligned in a planar patterned LC alignment (the LC molecules 705 may have a pretilt angle smaller than 15 degrees, including zero degree) to provide an optical power. The active off-axis focusing PBP lens 700 may operate in a focusing state for the RHCP light 702, and may converge the RHCP light 702 as an LHCP light 704. For example, when the RHCP light 702 is an on-axis collimated RHCP light, the active off-axis focusing PBP lens 700 may focus the on-axis collimated RHCP light to an off-axis focal point.

At a voltage-on state, as shown in FIG. 7B, the horizontal electric field may be generated in the optically anisotropic film 710 by electrodes disposed at the same substrate (e.g., the first substrate 711). The configuration of the electrodes for generating a horizontal electric field may include in-plane switching (“IPS”) electrodes or fringe-field switching (“FFS”) electrodes. For discussion purposes, FIGS. 7A and 7B show the active nematic LCs having a positive dielectric anisotropy. The LC molecules 705 may be reoriented along the direction of the horizontal electric field, and the optically anisotropic film 710 may function as an optical uniaxial film when the horizontal electric field is sufficiently strong. As a result, the patterned LC alignment configured to provide an optical power (shown in FIG. 7A) may be transformed to the uniform uniaxial planar structure (shown in FIG. 7B) that provides no or negligible optical power. As the phase retardation of the PBP lens 700 is a half wave or an odd number of half waves, the optically anisotropic film 710 may function as a half-wave plate. Thus, the active off-axis focusing PBP lens 700 operating in the neutral state may reverse the handedness of the light transmitted through the half-wave plate without focusing (or defocusing) the light. For example, as shown in FIG. 7B, the on-axis collimated RHCP light 702 incident onto the active off-axis focusing PBP lens 700 at the voltage-on state may be transmitted therethrough as an on-axis collimated LHCP light 706. That is, the LC molecules 705 may be rotated in-plane by the electric field to switch off the optical power of the active off-axis focusing PBP lens 700. The handedness of the light transmitted therethrough may be reversed.

For discussion purposes, FIGS. 6A and 6B and FIGS. 7A and 7B show the switching of active off-axis focusing PBP lenses including active nematic LCs with a positive dielectric anisotropy (e.g. positive LCs). In some embodiments, the active off-axis focusing PBP lens may include active nematic LCs with a negative dielectric anisotropy (e.g., negative LCs), which may be reorientable by applying a vertical electric field to activate the PBP lens. For example, at a voltage-off state, the negative LCs in the optically anisotropic film may be configured to be in a homeotropic state, and the optically anisotropic film may operate as an optically isotropic medium for the normally incoming light. Accordingly, the active off-axis focusing PBP lens may operate in a neutral state and may negligibly affect or may not affect the propagation direction, the wavefront, and the polarization handedness of the incoming light. When an applied vertical electric field (perpendicular to the substrates) is sufficiently strong, the directors of the negative LCs may be oriented substantially parallel to the substrate. That is, the negative LCs may be reoriented to be in a planar state with a patterned LC alignment according to patterns of the PAM layer. Accordingly, the active off-axis focusing PBP lens may operate in a focusing state or a defocusing state. In some embodiments, the active off-axis focusing PBP lens may include active nematic LCs with a negative dielectric anisotropy (e.g., negative LCs). The active nematic LCs with the negative dielectric anisotropy may be reorientable by applying a horizontal electric field to deactivate the PBP lens. For example, at a voltage-off state, the negative LCs in the optically anisotropic film may be aligned in a planar LC alignment pattern to provide an optical power. When an applied horizontal electric field is sufficiently strong, the negative LCs may be in-plane reoriented in the direction perpendicular to the direction of the horizontal electric field. The active off-axis focusing PBP lens may operate in the neutral state. In the neutral state, the optically anisotropic film may function as an optically uniaxial film. As the phase retardation of the PBP lens is a half wave or an odd number of half waves, the optically anisotropic film may function as a half-wave plate.

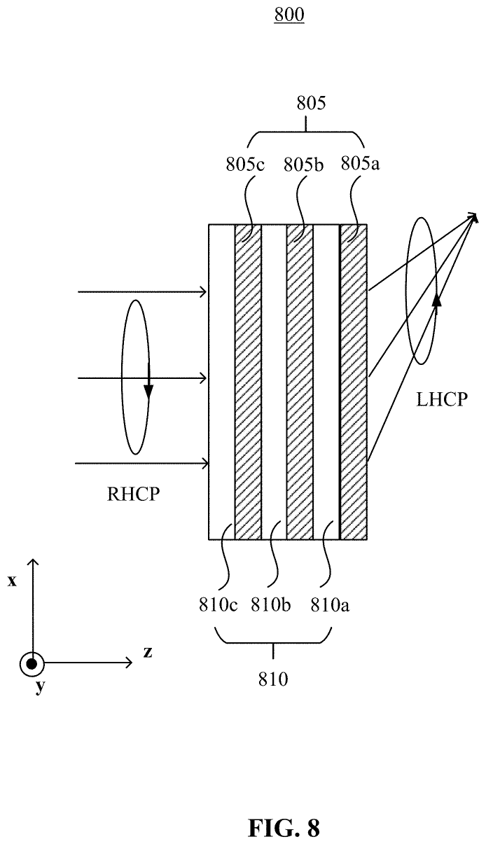

The present disclosure further provides a lens stack including a plurality of lenses. The plurality of lenses may include one or more disclosed off-axis focusing PBP lenses. In some embodiments, all of the lenses included in the lens stack may be off-axis focusing PBP lenses. In some embodiments, the lens stack may include a combination of at least one on-axis focusing PBP lens and at least one off-axis focusing PBP lens. FIG. 8 illustrates a schematic diagram of a lens stack 800 including one or more disclosed off-axis focusing PBP lenses, according to an embodiment of the present disclosure. As shown in FIG. 8, the lens stack 800 may include a plurality of lenses 805 (e.g., 805a, 805b, and 805c) arranged in an optical series. The plurality of lenses 805 may include one or more disclosed off-axis focusing PBP lenses, each of which may be an embodiment of the off-axis focusing PBP lenses described above in connection with FIGS. 1A-1D, and 3A-7B. For example, in some embodiments, the plurality of lenses 805 may also include one or more on-axis focusing PBP lenses. For example, one or more of the lenses 805a, 805b, and 805c may be an on-axis focusing PBP lens. In some embodiments, the plurality of lenses 805 may also include one or more other types of suitable lenses, such as one or more conventional lenses, e.g., one or more glass lenses.

The plurality of lenses 805 may provide a plurality of optical states. The plurality of optical states may provide a range of adjustments of optical powers and a range of adjustments of beam deviations for the lens stack 800. An optical power P of the lens stack 800 may be calculated by P=1/f (unit: diopter), where f is the focal length of the lens stack 800. The optical power P of the lens stack 800 may be a sum of the optical powers of the respective lenses 805 included in the lens stack 800. The optical powers of the respective lenses 805 may be positive, negative, or zero. The resultant beam deviations may depend on the shift of the structural center (or structural center shift) in the respective lenses 805 and the relative orientations between the lenses 805. For example, when the structural center is shifted in the x-axis by the lenses 805, the resultant structural center shift may be in the x-axis. The structural center shift of the lens stack 800 may be a sum of the structural center shifts of the lenses 805 included in the lens stack 800. The structural center shift of each of the lenses 805 may be positive, negative, or zero. For example, a structural center shift in the +x-axis with respective to the lens aperture center may be defined as a positive structural center shift, and a structural center shift in the −x-axis with respective to the lens aperture center may be defined as a negative lens aperture center shift.

In some embodiments, the lens stack 800 may be switchable between a focusing state (or a defocusing state) and a neutral state. In some embodiments, a focal distance and a deflection angle of a focused beam (or beam deviation of a focused beam) may be adjustable. Accordingly, a 2D and 3D beam steering with focusing may be realized. A 3D positioning of focal point may be, for example, useful for direct 3D optical recording in photo-sensitive materials. The switchable lens stack 800 may include one or more active PBP lenses, which may be directly switchable between the focusing state (or the defocusing state) and the neutral state by an electric field, as described in FIGS. 6A-7B. The one or more active PBP lenses may include an on-axis focusing PBP lens or a disclosed off-axis focusing PBP lens.

In some embodiments, the lens stack 800 may include at least one SHWP arranged adjacent to a PBP lens. For illustrative purposes, FIG. 8 shows that the lens stack 800 may include a plurality of SHWPs 810 (e.g., three SHWPs 810a, 810b, and 810c) and a plurality of PBP lenses 805 (e.g., three PBP lenses 805a, 805b, and 805c) alternately arranged. The SHWP 810 may be configured to reverse or maintain a handedness of a polarized light depending on an operating state of the SHWP, as described above in connection with FIGS. 5A and 5B. In some embodiments, the lenses 805 may include one or more active off-axis focusing PBP lenses, which may provide an optical power (zero or non-zero optical power) depending on the handedness of a circularly polarized light incident on the PBP lens 805, the handedness of LC director rotation in the PBP lens 805, and an applied voltage. A thickness of an individual PBP lens 805 (e.g., 805a, 805b, or 805c) may be 1-10 microns, which may be negligible when compared with a thickness of the substrate. Thus, an overall thickness of the lens stack 800 may be substantially determined by the thickness of the glass or plastic substrate(s). The overall thickness of the lens stack 800 may have a thickness of, for example, 1-10 millimeters. The lens stack 800 may provide an off-axis focusing capability without physically tilting the PBP lenses. Thus, the lens stack 800 fabricated based on one or more disclosed off-axis focusing PBP lenses may have a compactness that significantly reduces the form factor of an optical system including the lens stack 800. Although three lenses 805a, 805b, and 805c and three SHWPs 810a, 810b, and 810c are shown in FIG. 8 for illustrative purposes, the lens stack 800 may include any suitable number of lenses (including any suitable number of disclosed off-axis focusing PBP lenses), such as one, two, four, five, etc., and any suitable number of SHWPs, such as one, two, four, five, etc.

In some embodiments, the lens stack 800 may include one or more passive off-axis focusing PBP lenses, which may provide an optical power (zero or non-zero optical power) depending on the handedness of a circularly polarized light incident on the PBP lens 805 and the handedness of LC director rotation in the PBP lens 805. Thus, through controlling the operating state (switching or non-switching state) of the at least one SHWP 810 coupled with a corresponding off-axis focusing PBP lens 805, the lens stack 800 may provide a plurality of optical states. The plurality of optical states may provide a range of adjustments of optical powers and a range of adjustments of beam deviations for an incident light.

In some embodiments, the lens stack 800 may include both passive off-axis focusing PBP lenses and active off-axis focusing PBP lenses. Through controlling the operating state (switching or non-switching state) of the at least one SHWP 810 coupled with a corresponding passive off-axis focusing PBP lens, and controlling the operating state (switching or non-switching state) of the at least one SHWP 810 coupled with a corresponding active off-axis focusing PBP lens and an applied voltage of the active off-axis focusing PBP lens, the lens stack 800 may provide a plurality of optical states. The plurality of optical states may provide a range of adjustments of optical powers and a range of adjustments of beam deviations for the incident light.

The disclosed off-axis focusing PBP lens and the lens stack including one or more off-axis focusing PBP lenses may include features such as flatness, compactness, small weight, thin thickness, high efficiency, high aperture ratio, flexible design, simply fabrication, and low cost, etc. Thus, the disclosed off-axis focusing PBP lens and the lens stack may be implemented in various applications such as portable or wearable optical devices and systems. The disclosed off-axis focusing PBP lens and the lens stack including one or more off-axis focusing PBP lenses may provide complex optical functions while maintaining a small form factor, compactness and light weight. For example, the disclosed off-axis focusing PBP lenses and/or the lens stack including one or more off-axis focusing PBP lenses may be implemented in a near-eye display (“NED”). In some embodiments, the disclosed off-axis focusing PBP lenses and/or the lens stack including one or more off-axis focusing PBP lenses may be implemented in object-tracking (e.g., eye-tracking) components, display components, adaptive optical components for human eye vergence-accommodation, etc.

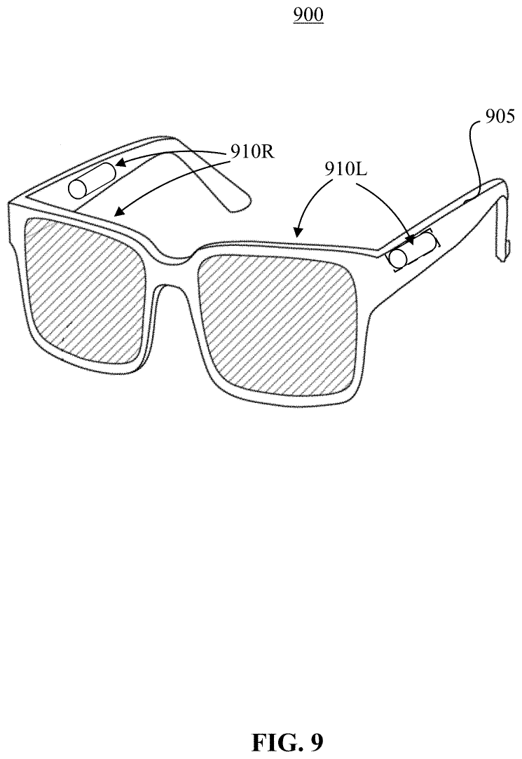

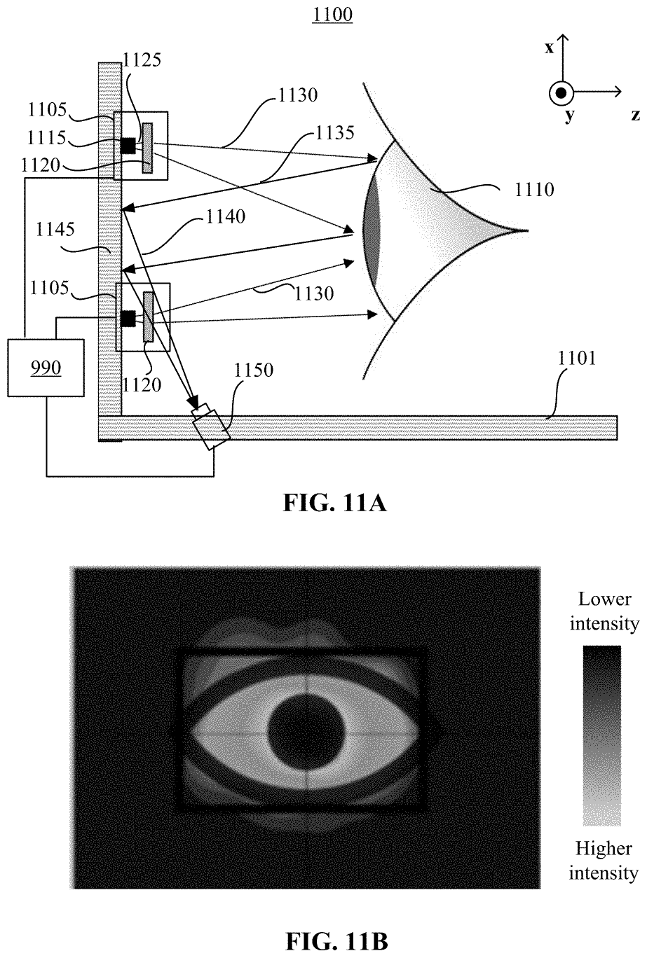

FIG. 9 illustrates a schematic diagram of a near-eye display (“NED”) 900, according to an embodiment of the present disclosure. As shown in FIG. 9, the NED 900 may include a frame 905, a right-eye display system 910R and a left-eye display system 910L mounted to the frame 905, and an object-tracking (e.g., eye-tracking) system (embodiment shown in FIG. 11A). The frame 905 may be coupled to one or more optical elements that together display media content to a user. In some embodiments, the frame 905 may represent a frame of eye-wear glasses. Each of the right-eye and left-eye display systems 910R and 910L may include image display componentry configured to project computer-generated virtual images into a right display window and a left display window in the field of view (“FOV”) of the user.

The NED 900 may function as a virtual reality (“VR”) device, an augmented reality (“AR”) device, a mixed reality (“MR”) device, or a combination thereof. In some embodiments, when the NED 900 functions as an AR and/or an MR device, the right and left display windows may be at least partially transparent to a light from a real-world environment to provide the user a view of the surrounding real-world environment. In some embodiments, when the NED 900 functions as a VR device, the right and left display windows may be opaque, such that the user may be immersed in the VR imagery provided via the NED 900. In some embodiments, the NED 900 may further include a dimming element, which may dynamically adjust the transmittance of real-world lights transmitted through the dimming element, thereby switching the NED 900 between functioning as a VR device and an AR device or between functioning as a VR device and an MR device. In some embodiments, along with switching between functioning as an AR or MR device and the VR device, the dimming element may be implemented in the AR device to mitigate differences in brightness of real and virtual image lights.

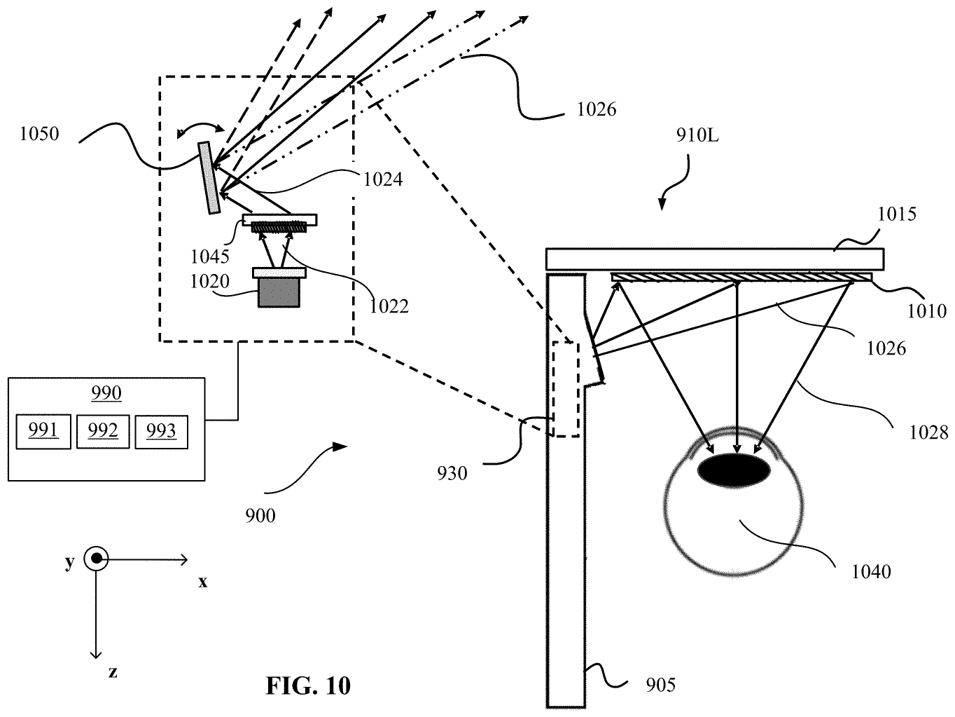

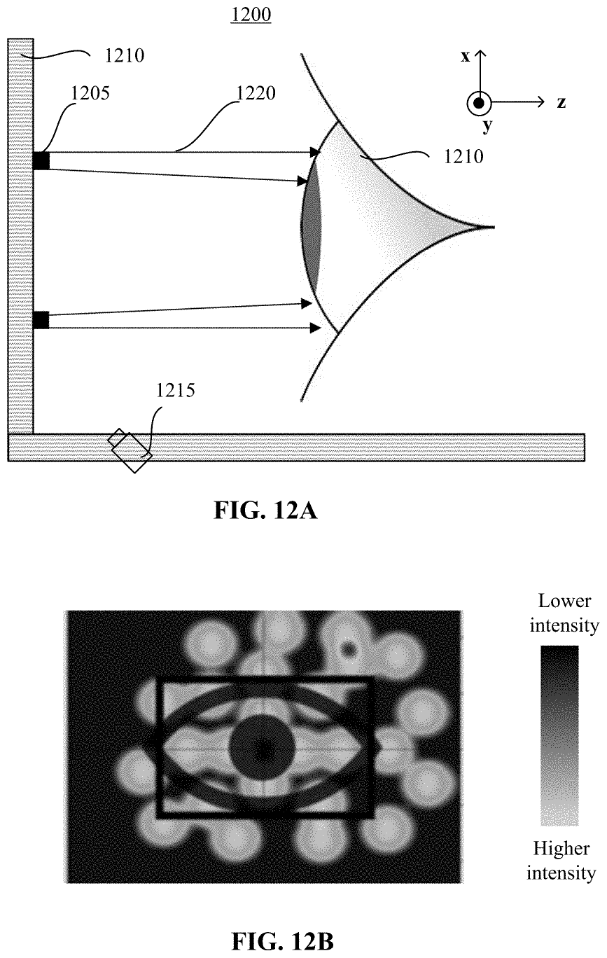

In some embodiments, the NED 900 may include one or more optical elements between the right and left display systems 910R and 910L and the eye 920. The optical elements may be configured to correct aberrations in an image light emitted from the right and left display systems 910R and 910L, magnify an image light emitted from the right and left display system 910R and 910L, or perform other optical adjustments of an image light emitted from the right and left display system 910R and 910L. Examples of the optical elements may include an aperture, a Fresnel lens, a convex lens, a concave lens, a filter, a polarizer, or any other suitable optical element that affects the image light. Exemplary right and left display systems 910R and 910L including one or more of the disclosed off-axis focusing PBP lenses or lens stacks will be described in detail with reference to FIG. 10 and FIG. 12.

FIG. 10 illustrates a cross-section of the left half of the NED 900 shown in FIG. 9, facing a left eye 1040 of a user. The left-eye display system 910L may include one or more disclosed off-axis focusing PBP lenses and/or one or more disclosed lens stacks each including one or more disclosed off-axis focusing PBP lenses. FIG. 10 illustrates an off-axis focusing PBP lens may be implemented into a laser beam scanning projector of an NED. In some embodiments, the left-eye display system 910L may include a display assembly 930 and an optical combiner 1010 mounted on a left portion of the frame 905. It is understood that a similar display assembly 930 and a similar optical combiner 1010 may be separately disposed on a right portion of the frame 905 to provide an image light to an eye-box located at an exit pupil of the right eye of the user.

The display assembly 930 shown in FIG. 10 may include a light source 1020, an optical element 1045 including an off-axis focusing PBP lens (hence the optical element 1045 may also be referred to as the off-axis focusing PBP lens 1045), and a micro-electromechanical system (“MEMS”) 1050. The display assembly 930 may include other elements, which are not limited by the present disclosure. The light source 1020 may be configured to emit an image light. The off-axis focusing PBP lens 1045 may be configured to collimate and deflect the image light received from the light source 1020. In some embodiments, the off-axis focusing PBP lens 1045 may be configured to output an off-axis collimated image light towards the MEMS 1050. The off-axis focusing PBP lens 1045 may be an embodiment of any of the disclosed off-axis focusing PBP lenses. In some embodiments, the off-axis focusing PBP lens 1045 may be replaced by a disclosed lens stack including one or more off-axis focusing PBP lenses. In some embodiments, the MEMS 1050 may include electrically rotatable mirrors configured to steer a light in one dimension or in two dimensions. The MEMS 1050 may be configured to redirect the image light received from the off-axis focusing PBP lens 1045 to the optical combiner 1010. The MEMS 1050 may be an example of a beam steering device. In some embodiments, the MEMS 1050 may be replaced by another suitable beam steering device. The optical combiner 1010 may be configured to redirect the image light received from the MEMS 1050 to an eye-box of the NED 900.

The NED 900 may include a controller 990. The controller 990 may include a processor 991, a memory 991, and an input/output device (e.g., a communication device) 993. The processor 991 may be any suitable processor configured with a computing capability, such as a central processing unit (“CPU”), a graphics processing unit (“GPU”), etc. The memory 991 may be any suitable memory, such as a read-only memory (“ROM”), a random-access memory (“RAM”), a flash memory, etc. The input/output device 993 may include any suitable input/output interface or port configured to output or receive data to or from an external device. In some embodiments, the input/output device 993 may be a communication device configured for wired and/or wireless communications, such as a WiFi module, a Bluetooth module, etc. In some embodiments, the controller 990 may not be included in the NED 900. Instead, the controller 990 may be a remote controller communicatively coupled with the NED 900. For discussion purposes, the controller 990 is presumed to be included in the NED 900. The controller 990 may be communicatively coupled with various devices included in the NED 900, and may be configured to control the operations of the devices or receive information from the devices. For example, the controller 990 may be configured to control the light source 1020 and the off-axis focusing PBP lens 1045, and/or the MEMS 1050.

In some embodiments, the display assembly 930 may be a laser beam scanning projector. The light source 1020 may be configured to emit an image light 1022 with a narrow emission spectrum, e.g., a light beam 1022. For example, the light source 1020 may include at least one of a laser diode or a vertical cavity surface emitting laser (“VCSEL”) configured to emit a laser beam. The light beam 1022 may be a diverging on-axis laser beam with the divergence degree depending on the light source 1020. The light source 1020 may be disposed at an off-axis location with respect to the optical combiner 1010. The display assembly 930 may include one or more optical elements (including the off-axis focusing PBP lens 1045) configured to condition the light beam 1022 received from the light source 1020. Conditioning the light beam 1022 may include, e.g., transmitting, attenuating, expanding, collimating, polarizing, and/or adjusting orientation of the light beam 1022. The off-axis focusing PBP lens 1045 may be disposed at an off-axis location with respect to the optical combiner 1010. The light source 1020 may be disposed at an intersection of an out-of-plane geometry center axis and a focal plane of the off-axis focusing PBP lens 1045 configured for a wavelength of interest or a wavelength range of interest. In the embodiment shown in FIG. 10, the light beam 1022 may be an on-axis laser beam with respect to the out-of-plane geometry center axis of the off-axis focusing PBP lens 1045, and the off-axis focusing PBP lens 1045 may be configured to collimate and deflect the light beam 1022 emitted from the light source 1020 toward the MEMS 1050.

In some embodiments, the light beam 1022 may be a circularly polarized light beam with a predetermined handedness. In some embodiments, the light beam 1022 may be a linearly polarized light beam. The display assembly 930 may include a quarter-wave plate (not shown in FIG. 10) disposed between the off-axis focusing PBP lens 1045 and the light source 1020 to convert the linearly polarized light beam 1022 to a circularly polarized light beam with a predetermined handedness. In some embodiments, the light beam 1022 may be an unpolarized light beam. The display assembly 930 may include a suitable optical element (e.g., a circular polarizer) or a suitable combination of optical elements (e.g., a combination of a linear polarizer and a quarter-wave plate) disposed between the off-axis focusing PBP lens 1045 and the light source 1020 to convert the light beam 1022 to a circularly polarized light beam with a predetermined handedness. The off-axis focusing PBP lens 1045 may convert the circularly polarized light beam with a predetermined handedness into a collimated light beam 1024 (which may be a circularly polarized light beam having an opposite handedness), and may direct the collimated light beam 1024 toward the MEMS 1050. The collimated light beam 1024 may be an off-axis collimated light beam 1024 with respect to the out-of-plane geometry center axis of the off-axis focusing PBP lens 1045.

The MEMS 1050 may be disposed between the off-axis focusing PBP lens 1045 and the optical combiner 1010. The MEMS 1050 may include electrically rotatable mirrors that are rotatable to steer the light beam 1026, thereby scanning the light beam 1026 across the optical combiner 1010. In some embodiments, each scanned angle of the light beam 1026 may correspond to a point (pixel) of the image. In some embodiments, the light source 1020 may include a single illuminator, e.g., a single laser diode or a single VCSEL. The off-axis focusing PBP lens 1045 may function as a spherical lens that converts the on-axis diverging light beam 1022 into the off-axis collimated light beam 1024. The MEMS 1050 may be a two-dimensional (“2D”) scanning MEMS configured to steer the light beam 1026 across the optical combiner 1010 in two dimensions. Thus, the light beam 1026 may be scanned in two dimensions by the MEMS 1050 across the optical combiner 1010 to provide a 2D image. In some embodiments, the light source 1020 may include a one-dimensional (“1D”) array of illuminators, e.g., a 1D array of micro-lasers or micro-LEDs. The off-axis focusing PBP lens 1045 may function as a cylindrical off-axis focusing PBP lens or a 1D off-axis focusing PBP lens array. The MEMS 1050 may be a one-dimensional (“1D”) scanning MEMS configured to steer the light beam 1026 across the optical combiner 1010 in one dimension. Thus, the light beam 1026 may be scanned by the MEMS 1050 across the optical combiner 1010 in one dimension to provide a 2D image.

In some embodiments, the optical combiner 1010 may be disposed at a substrate 1015 facing the eye 1040 of a user. The substrate 1015 may be transparent in at least a portion of the visible band (e.g., about 380 nm to about 700 nm). In some embodiments, the optical combiner 1010 and the substrate 1015 may be integrated as an eyepiece in a monocular or binocular NED. In some embodiments, the optical combiner 1010 may be configured to direct the light beam 1026 received from the MEMS 1050 to the eye-box of the NED 900, such that the eye 1040 of the user may observe a virtual image. When configured for AR applications, the optical combiner 1010 may combine the light beam 1026 forming a virtual image and a light from a real-world environment, and direct the combined lights toward the eye-box of the NED 900. Accordingly, the user may observe the virtual image optically combined with a view of real-world objects (e.g., with the virtual image superimposed on the user's view of real-world scene).

In some embodiments, the optical combiner 1010 may be configured to direct the light beam 1026 that is scanned across the optical combiner 1010 to an eye-box of the NED 900, such that the eye 1040 of the user may observe a virtual image. The optical combiner 1010 may be any suitable optical combiner. In some embodiments, the optical combiner 1010 may include a holographic optical element (“HOE”). In some embodiments, the HOE may include one or more multiplexed reflective Bragg gratings configured to redirect the light beam 1026 that is scanned across the optical combiner 1010 to the eye 1040. In some embodiments, the reflective Bragg gratings may be strongly wavelength selective, and the light source 1020 may be configured to emit an image light with a narrow emission spectrum, e.g., a laser beam. In the disclosed embodiments, the off-axis focusing PBP lens 1045 may allow for a more compact design of the NED 900. The more compact design may be desirable when the NED 900 is worn as an eyewear to the user's head. The off-axis design provides an optical path that more closely conforms to the shape of the head and the shape of a conventional eyewear. Thus, the off-axis design enables the NED 900 to have a smaller form factor than a conventional on-axis design.

The use of a disclosed off-axis focusing PBP lens in the laser beam scanning projector shown in FIG. 10 is for illustrative purposes. The light beam scanning principle with the disclosed off-axis focusing PBP lens may be extended to waveguide displays in which different light sources, e.g., diode lasers, vertical cavity surface emitting lasers (“VCSELs”), super-luminescent light-emitting diodes (“SLED”), organic light-emitting diodes (“OLEDs”), light-emitting diodes (“LEDs”), micro-LEDs, may be used. In some embodiments, light sources providing a higher intensity and a smaller solid angle of emission (which may be considered as a “beam”), e.g., diode lasers, VCSELs, SLEDs, may be desirable. In some embodiments, the light source may be a substantial point light source, which may be disposed substantially at an intersection of an out-of-plane geometry center axis and a focal plane of the off-axis focusing PBP lens configured for a wavelength of interest or a wavelength range of interest.

In some embodiments, the disclosed off-axis focusing PBP lens or lens stack may be used in other types of projection display systems to improve the form factor, such as a liquid-crystal-on-silicon (“LCoS”) projector system, a digital light processing (“DLP”) projector system, or a liquid crystal display (“LCD”) projector system, etc. In some embodiments, the light source 1020 may include a display panel, such as a liquid crystal display (“LCD”) panel, a liquid-crystal-on-silicon (“LCoS”) display panel, a light-emitting diode (“LED”) display panel, an organic light-emitting diode (“OLED”) display panel, a micro light-emitting diode (“micro-LED”) display panel, a digital light processing (“DLP”) display panel, or a combination thereof. In some embodiments, the light source 1020 may include a self-emissive panel, such as an OLED display panel or a micro-LED display panel. In some embodiments, the light source 1020 may include a display panel that is illuminated by an external source, such as an LCD panel, an LCoS display panel, or a DLP display panel. Examples of an external sources may include a micro-LED, an LED, an OLED, or a combination thereof.

The optical combiner 1010 that includes an HOE shown in FIG. 10 is for illustrative purposes. In some embodiments, the optical combiner 1010 may include a diffractive waveguide combiner including a waveguide coupled with an in-coupling diffractive element and an out-coupling diffractive element. The in-coupling diffractive element may be configured to couple an image light received from an image projector into the waveguide via diffraction, and the out-coupling diffractive element may be configured to couple the image light out of the waveguide toward the eye-box via diffraction. The in-coupling diffractive element and out-coupling diffractive element may include surface relief gratings, volume holograms, polarization gratings, polarization volume holograms, metasurface gratings, other types of diffractive elements, or a combination thereof. In some embodiments, the optical combiner 1010 may include a reflective element coupled to receive and reflect an image light received from an image projector toward the eye-box. In some embodiments, similar scanning principles used for the laser beam scanning projector may be applied to a diffractive waveguide combiner, a semi-transparent mirror combiner, etc. For example, for the diffractive waveguide combiner, the MEMS 1050 may scan the light beam 1026 at the in-coupling diffractive element. In some embodiments, the in-coupling diffractive element and out-coupling diffractive element may include gratings that are weakly wavelength selective (e.g., some surface relief gratings, some PBP gratings). The light source 1020 may be configured to emit an image light with a broader emission spectrum (e.g., LEDs, micro-LEDs, etc.).

FIG. 11A illustrates a schematic diagram of an object-tracking system 1100 for tracking an object 1110, according to an embodiment of the present disclosure. For illustrative purposes, an eye-tracking system is shown in FIG. 11A as an example of the object-tracking system 1100, and an eye 1110 is used as an example of a tracked object. For discussion purposes, the object-tracking system 1100 may be referred to as an eye-tracking system 1100. The eye-tracking system 1100 may be implemented in the NED 900 or in combination with the NED 900. The eye-tracking system 1100 may include a disclosed off-axis focusing PBP lens and/or a lens stack including one or more disclosed off-axis focusing PBP lenses. The controller 990 may be communicatively coupled with one or more components of the eye-tracking system 1100, and may control the operations of the eye-tracking system 1100. In some embodiments, the controller 990 may receive data from the eye-tracking system 1100, such as eye-tracking information and/or image data of an eye 1110. In some embodiments, the controller 990 may send commands or instructions to the eye-tracking system 1100 to control the operations of the eye-tracking system 1100. The controller 990 may or may not be a part of the eye-tracking system 1100.

As shown in FIG. 11A, the eye-tracking system 1100 may be an optical system configured to obtain eye-tracking information or images from which eye-tracking information may be extracted. It is understood that such an optical system may be used to track any suitable object other than an eye of a user. In some embodiments, the eye-tracking system 1100 may include at least one source assembly 1105 configured to emit a light (e.g., an infrared light) to illuminate the eye 1110 of a user. The source assembly 1105 may be positioned out of a line of sight of the user. The source assembly 1105 may include a light source 1115 configured to emit a light and one or more optical components disposed between the light path of the light source 1115 and the eye 1110. The one or more optical components may be configured to condition a light generated by the light source 1115 and direct the conditioned light to illuminate the eye 1110. The controller 990 may be communicatively coupled with the light source assembly 1105, and may control the one or more optical components to perform conditioning of the light from the light source 1115, such as polarizing, collimating, expanding and/or adjusting orientation of the light.

In some embodiments, the light source 1115 may emit a light having a relatively narrow spectrum or a relatively broad spectrum. One or more wavelengths of the light may be in the infrared (“IR”) spectrum, i.e., the spectrum of the light source 1115 may be within, overlap, or encompass the IR spectrum. In some embodiments, the light source 1115 may emit lights in the near infrared (“NIR”) band (centered at about 750 nm to 1250 nm), or some other portion of the electromagnetic spectrum. NIR spectrum lights may be desirable in eye-tracking applications because the NIR spectrum lights are not visible to the human eye and thus, do not distract the user of the NED 900 during operation. The lights at the IR spectrum or the NIR spectrum are collectively referred to as infrared lights. The infrared lights may be reflected by at least a pupil area of the eye 1110 (including an eye pupil and skins surrounding the eye pupil). The light source 1115 may have a small size to reduce or suppress disturbance of an image light that is emitted from a light source and directed to the eye 1110. The light source 1115 may include, e.g., a laser diode, a fiber laser, a vertical-cavity surface-emitting laser (“VCSEL”), and/or an LED. In some embodiments, the light source 1110 may include a micro-LED.

In some embodiments, the eye-tracking system 1100 may further include a redirecting element 1145 configured to direct a light reflected by the eye 1110 toward an optical sensor 1150 (or imaging device 1150). In some embodiments, when the NED 900 is used for AR applications, the redirecting element 1145 may also function as an eye-tracking combiner. The eye-tracking combiner may be configured to redirect the light reflected by the eye 1110 toward the optical sensor 1150. The eye-tracking combiner may also be configured to superimpose computer-generated virtual images onto a direct view of the real world. The redirecting element 1145 (e.g., eye tracking combiner) may be substantially transparent for real-world lights and may not cause distortion in a visible light. In the embodiment shown in FIG. 11A, the redirecting element 1145 may include one or more reflective gratings. The reflective grating may be configured with a zero or non-zero optical power (i.e., the grating may or may not converge or diverge a light). In some embodiments, the reflective grating may include a holographic optical element (“HOE”). In some embodiments, the reflective grating may include a polarization selective (or sensitive) grating, such as a polarization volume hologram (“PVH”) grating. In some embodiments, the reflective grating may include a non-polarization selective (or sensitive) grating, such as a volume Bragg grating (“VBG”).

The optical sensor 1150 may be arranged relative to the redirecting element 1145, to receive the light from the redirecting element 1145 and generate an image of the eye 1110 (or a portion of the eye 1110 including an eye pupil) based on the received light for eye-tracking purposes. The optical sensor 1150 may be configured to form images based on lights having a wavelength within a spectrum that includes the IR spectrum. In some embodiments, the optical sensor 1150 may be configured to form images based on IR lights but not visible lights. In some embodiments, the optical sensor 1150 may include a suitable type of camera, for example, a silicon-based charge-coupled device (“CCD”) array camera, a complementary metal-oxide-semiconductor (“CMOS”) sensor array camera, a camera having an infrared sensitive (e.g. near-infrared, short-infrared, mid-wave infrared, long-wave infrared sensitive) focal plane array (e.g., a mercury cadmium telluride array, an indium antimonide array, an indium gallium arsenide array, a vanadium oxide array, etc). In some embodiments, the optical sensor 1150 may include a position sensitive detector (“PSD”). The optical sensor 1150 may be mounted at any suitable part of the eye-tracking system 1100 to face the redirecting element 1145 to receive the lights reflected from the eye 1110.

In some embodiments, the optical sensor 1150 may be mounted on a frame 1101 of the NED 900. In some embodiments, the optical sensor 1150 may include a processor configured to process the received IR lights to generate one or more images of the eye 1110, and/or to analyze the images of the eye 1110 to obtain the eye-tracking information. The eye-tracking information may be transmitted to the controller 990 for determining controls of other optical devices or systems, for determining information to be presented to the user, and/or for determining the layout of the presentation of the information, etc. In some embodiments, the optical sensor 1150 may also include a non-transitory computer-readable storage medium (e.g., a computer-readable memory) configured to store data, such as the generated images. In some embodiments, the non-transitory computer-readable storage medium may store codes or instructions that may be executable by the processor to perform various steps of any method disclosed herein. In some embodiments, the processor and the non-transitory computer-readable medium may be provided separately from the optical sensor 1150. For example, the processor may be communicatively coupled with the optical sensor 1150 and configured to receive data (e.g., image data) from the optical sensor 1150. The processor may be configured to analyze the data (e.g., image data of the eye 1110) received from the optical sensor 1150 to obtain the eye-tracking information.

In one embodiment, as shown in FIG. 11A, the one or more optical components disposed between the light path of the light source 1115 and the eye 1110 may include an off-axis focusing PBP lens 1120. In some embodiments, the light source 1115 may emit a light 1125, which may be a circularly polarized light with a predetermined handedness. The off-axis focusing PBP lens 1120 may be configured to diverge the light 1125 to illuminate the eye 1110. That is, the off-axis focusing PBP lens 1120 may expand and redirect the light 1125 to illuminate the eye 1110. Accordingly, a substantially uniform illumination may be provided by the off-axis focusing PBP lens 1120 to at least a corneal area of the eye 1110 within a limited distance between the eye 1110 and the light source 1115. For example, the uniform illumination may be provided to the entire eye 1110 of the user, to an area adjacent the eye 1110, such as above, below, left to, or right to the eye 1110 of the user, or to an area including the eye 1110 and an area surrounding the eye 1110 within a limited distance between the eye 1110 and the light source 1115. In some embodiments, the light 1125 emitted from the light source 1115 may be conditioned to be an on-axis collimated LHCP light that is incident onto the off-axis focusing PBP lens 1120. The off-axis focusing PBP lens 1120 may operate in a defocusing state for an LHCP light and may defocus the on-axis collimated LHCP light 1125 as an off-axis diverging RHCP light 1130 that illuminates the eye 1110. The off-axis diverging RHCP light 1130 may be reflected by the eye 1110 as a light 1135, which is received by the redirecting element 1145 and redirected by the redirecting element 1145 as a light 1140 toward the optical sensor 1150. The optical sensor 1150 may generate an image of the eye 1110 based on the received light 1140.

In some embodiments, the light emitted from the light source 1115 may be a linearly polarized light. A quarter-wave plate may be disposed between the light source 1115 and the off-axis focusing PBP lens 1120 to convert the linearly polarized light into a circularly polarized light with a desirable handedness. In some embodiments, the light emitted from the light source 1115 may be an unpolarized light. A suitable optical element (e.g., a circular polarizer) or a suitable combination of optical elements (e.g., a combination of a linear polarizer and a quarter-wave plate) that converts an unpolarized light to a circularly polarized light may be disposed between the light source 1115 and the off-axis focusing PBP lens 1120.

Through configuring the parameters of the off-axis focusing PBP lens 1120 and the polarization of the light 1125 incident onto the off-axis focusing PBP lens 1120, the off-axis diverging RHCP light 1130 output from the off-axis focusing PBP lens 1120 may provide a substantially uniform illumination of at least a corneal area of the eye 1110). For example, the off-axis focusing PBP lens 1120 may provide a uniform illumination of the entire eye 1110 of the user, of an area adjacent the eye 1110, such as above, below, left to, or right to the eye 1110 of the user, or of an area including the eye 1110 and an area surrounding the eye 1110, within a limited distance between the eye 1110 and the light source 1115. With the uniform illumination of the eye 1110, better images of the eye 1110 can be captured by the optical sensor 1150. Accordingly, the accuracy of the eye-tracking may be enhanced. In addition, the eye-tracking system 1100 may have attractive features, such as a small form factor, compactness, and light weight.

FIG. 11A shows two source assemblies 1105, one eye 1110 and the optical paths of the light from the source assemblies 1105 for illustrative purposes. It is understood that similar or the same components may be included in the NED 900 for tracking the other eye, which are not shown in FIG. 11A.

FIG. 11B illustrates a light intensity distribution at the tracked object (e.g., the eye 1110) provided by the object-tracking system (e.g., eye-tracking system) 1100 shown in FIG. 11A. The gray level bar indicates the light intensity at the eye 1110, where a darker color denotes a lower light intensity. Referring to FIG. 11A and FIG. 11B, under the illumination of the off-axis diverging RHCP light 1130, the light intensity distribution may be substantially uniform at the eye 1110 and an area surrounding the eye 1110. That is, the off-axis focusing PBP lens 1120 may provide a substantially uniform illumination at the eye 1110 within a limited distance between the eye 1110 and the light source 1115. The disclosed off-axis focusing PBP lens 1120 may maintain the small form factor while enhancing the eye-tracking accuracy of the eye-tracking system 1100.

FIG. 12A illustrates a schematic diagram of a conventional eye-tracking system 1200 that does not include an off-axis focusing PBP lens for defocusing a light from a light source. As shown in FIG. 12A, the conventional eye-tracking system 1200 may include a light source 1205 configured to emit a light to illuminate an eye 1210 of a user. The conventional eye-tracking system 1200 may also include a redirecting element 1210 configured to guide a light reflected by the eye 1210 toward an optical sensor 1215. The light source 1205 may emit a substantially collimated light or a diverging light 1220, which may only illuminate certain regions of the eye 1210. FIG. 12B illustrates a light intensity distribution at the eye 1210 provided by the eye-tracking system 1200 shown in FIG. 12A. The gray level bar indicates the light intensity at the eye 1210, where a darker color denotes a lower light intensity. Referring to FIG. 12A and FIG. 12B, under the illumination of the light 1220, the light intensity distribution at the eye 1210 and an area surrounding the eye 1210 is non-uniform, where some portions have a substantially low light intensity while other portions have a substantially high intensity. Such a non-uniform illumination at the eye 1210 may significantly reduce the accuracy of the eye-tracking.

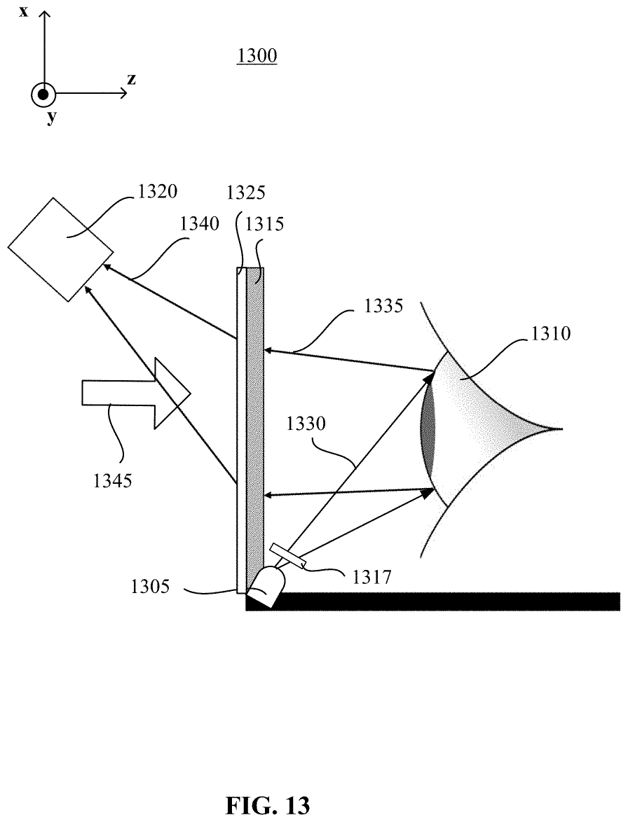

FIG. 13 illustrates a schematic diagram of an object-tracking system 1300 for tracking an object 1310, according to another embodiment of the present disclosure. For illustrative purposes, an eye-tracking system for tracking an eye is used as an example of the object-tracking system 1300. The eye is an example of the tracked object. Hence, for discussion purposes, the object-tracking system 1300 may also be referred to as an eye-tracking system 1300. The eye-tracking system 1300 may be included in the NED 900 shown in FIG. 9 or may be implemented in combination with the NED 900. The eye-tracking system 1300 may include an off-axis focusing PBP lens and/or a lens stack including one or more off-axis focusing PBP lenses. As shown in FIG. 13, the eye-tracking system 1300 may include a light source 1305 configured to emit a light to illuminate an eye 1310 of a user. The eye-tracking system 1300 may include an optical combiner 1315 configured to guide a light reflected by the eye 1310 toward an optical sensor 1320. The optical sensor 1320 may be orientated to receive the light reflected by the eye 1310 and generate an image of the eye 1310 based on the light received from the optical combiner 1315. The light source 1305 and the optical sensor 1320 may be similar to the light source 1115 and the optical sensor 1150 shown in FIG. 11A, respectively. Descriptions of the similar elements can refer to the descriptions rendered above in connection with FIG. 11A. When the NED 900 is implemented in AR applications, the optical combiner 1315 may also be configured to transmit a visible light 1345 from a real world toward the eye 1310, such that the eye 1310 may observe a virtual image optically combined with a view of a real world scene, thereby achieving an optical see-though AR or MR device. The optical combiner 1315 may also be referred to as an eye-tracking combiner. The eye-tracking combiner may be configured to direct the light reflected by the eye 1310 toward the optical sensor 1320, and to superimpose computer-generated virtual images onto the direct view of the real world. The optical combiner 1315 may be substantially transparent for the real world lights and may not cause distortion in the visible lights.

In the disclosed embodiments, as shown in FIG. 13, the optical combiner 1315 may include a transmissive PBP grating with a zero or non-zero optical power, e.g., an off-axis focusing transmissive PBP lens. In some embodiments, the light source 1305 may emit a light 1330, which may be a circularly polarized light having a predetermined handedness. The light 1330 may be reflected by the eye 1310 as a light 1335. The optical combiner 1315 may be configured to redirect (and converge when the optical combiner 1315 includes a disclosed off-axis focusing transmissive PBP lens) the light 1335 reflected by the eye 1310 toward the optical sensor 1320 as a light 1340. For example, when the optical combiner 1315 includes a disclosed off-axis focusing PBP lens, the light 1330 emitted from the light source 1305 may be an LHCP diverging light. When the LHCP diverging light 1330 is reflected by the eye 1310 as a reflected light 1335, the reflected light 1335 may be a diverging RHCP light. When the reflected light 1335 is incident onto the optical combiner 1315 having an off-axis focusing transmissive PBP lens, the reflected light 13135 may be converted as the off-axis converging light 1340 by the off-axis focusing transmissive PBP lens. The optical combiner 1315 may direct the off-axis converging light 1340 toward the optical sensor 1320. The off-axis converging light 1340 output from the off-axis focusing PBP lens included in the optical combiner 1315 may be an LHCP light.

The optical combiner 1315 may have a first surface facing the eye 1310 and an opposing second surface facing the real world. In some embodiments, the eye-tracking system 1300 may further include a circular polarizer 1325 disposed at the second surface of the optical combiner 1315. The circular polarizer 1325 may be configured to substantially transmit the light output from the optical combiner 1315 toward the optical sensor 1320. When the NED 900 is implemented in AR applications, an unpolarized light from the real-world may be converted into a circularly polarized light after passing through the circular polarizer 1325. The optical combiner 1315 may be configured to redirect (and converge when the optical combiner 1315 includes a disclosed off-axis focusing transmissive PBP lens) the received circularly polarized light toward the eye 1310.

In some embodiments, the light 1330 emitted from the light source 1305 may be a linearly polarized light, and a quarter-wave plate may be coupled to the light source 1305 to convert the linearly polarized light into a circularly polarized light with a desirable handedness. In some embodiments, the light 1330 emitted from the light source 1305 may be an unpolarized light. A suitable optical element (e.g., a circular polarizer) or a suitable combination of optical elements (e.g., a combination of a linear polarizer and a quarter-wave plate) may be coupled to the light source 1305 to convert the unpolarized light into a circularly polarized light with a desirable handedness.

In some embodiments, the eye-tracking system 1300 may also include an off-axis focusing PBP lens 1317 disposed between the light source 1035 and the eye 1310. The off-axis focusing PBP lens 1317 may be an embodiment of the off-axis focusing PBP lens 1120 shown in FIG. 11A, or any suitable off-axis focusing PBP lens disclosed herein. The descriptions of the off-axis focusing PBP lens 1317 may refer to the descriptions rendered above in connection with the disclosed off-axis focusing PBP lenses. The off-axis focusing PBP lens 1317 may be configured to diverge a light emitted from the light source 1035 to illuminate the eye 1110. For example, the light emitted from the light source 1035 may be a circularly polarized light with a predetermined handedness. The off-axis focusing PBP lens 1317 may be configured to convert the circularly polarized light emitted from the light source 1035 into an off-axis diverging light, thereby providing a substantially uniform illumination of at least a corneal area of the eye 1310 within a limited distance between the eye 1310 and the light source 1315. For example, the uniform illumination may be provided to the entire eye 1310 of the user, to an area adjacent the eye 1310, such as above, below, left to, or right to the eye 1310 of the user, or to an area including the eye 1310 and an area surrounding the eye 1310. With the uniform illumination of the eye 1310, better images of the eye 1310 can be captured by the optical sensor 1320. As a result, the accuracy of the eye-tracking may be enhanced. In addition, the eye-tracking system 1300 may have attractive features such as a small form factor, compactness, and light weight.

Some portions of this description may describe the embodiments of the disclosure in terms of algorithms and symbolic representations of operations on information. These operations, while described functionally, computationally, or logically, may be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware and/or software modules, alone or in combination with other devices. In one embodiment, a software module is implemented with a computer program product including a computer-readable medium containing computer program code, which can be executed by a computer processor for performing any or all of the steps, operations, or processes described. In some embodiments, a hardware module may include hardware components such as a device, a system, an optical element, a controller, an electrical circuit, a logic gate, etc.

Embodiments of the disclosure may also relate to an apparatus for performing the operations herein. This apparatus may be specially constructed for the specific purposes, and/or it may include a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. The non-transitory computer-readable storage medium can be any medium that can store program codes, for example, a magnetic disk, an optical disk, a read-only memory (“ROM”), or a random access memory (“RAM”), an Electrically Programmable read only memory (“EPROM”), an Electrically Erasable Programmable read only memory (“EEPROM”), a register, a hard disk, a solid-state disk drive, a smart media card (“SMC”), a secure digital card (“SD”), a flash card, etc. Furthermore, any computing systems described in the specification may include a single processor or may be architectures employing multiple processors for increased computing capability. The processor may be a central processing unit (“CPU”), a graphics processing unit (“GPU”), or any processing device configured to process data and/or performing computation based on data. The processor may include both software and hardware components. For example, the processor may include a hardware component, such as an application-specific integrated circuit (“ASIC”), a programmable logic device (“PLD”), or a combination thereof. The PLD may be a complex programmable logic device (“CPLD”), a field-programmable gate array (“FPGA”), etc.

Further, when an embodiment illustrated in a drawing shows a single element, it is understood that the embodiment or another embodiment not shown in the figures but within the scope of the present disclosure may include a plurality of such elements. Likewise, when an embodiment illustrated in a drawing shows a plurality of such elements, it is understood that the embodiment or another embodiment not shown in the figures but within the scope of the present disclosure may include only one such element. The number of elements illustrated in the drawing is for illustration purposes only, and should not be construed as limiting the scope of the embodiment. Moreover, unless otherwise noted, the embodiments shown in the drawings are not mutually exclusive. The disclosed embodiments described in the specification and/or shown in the drawings be combined in any suitable manner. For example, elements shown in one embodiment (e.g., in one figure) but not another embodiment (e.g., in another figure) may nevertheless be included in the other embodiment. Elements shown in one embodiment (e.g., in one figure) may be repeated to form a stacked configuration. Elements shown in different embodiments (e.g., in different figures) may be combined to form a variation of the disclosed embodiments. Elements shown in different embodiments may be repeated and combined to form variations of the disclosed embodiments. Elements mentioned in the descriptions but not shown in the figures may still be included in a disclosed embodiment or a variation of the disclosed embodiment. For example, in an optical device or system disclosed herein including one or more optical layers, films, plates, or elements, the numbers of the layers, films, plates, or elements shown in the figures are for illustrative purposes only. In other embodiments not shown in the figures, which are still within the scope of the present disclosure, the same or different layers, films, plates, or elements shown in the same or different figures/embodiments may be combined and/or repeated in various manners to form variations of the disclosed embodiments. These variations of the disclosed embodiments are also within the scope of the present disclosure.

Various embodiments have been described to illustrate the exemplary implementations. Based on the disclosed embodiments, a person having ordinary skills in the art may make various other changes, modifications, rearrangements, and substitutions without departing from the scope of the present disclosure. Thus, while the present disclosure has been described in detail with reference to the above embodiments, the present disclosure is not limited to the above described embodiments. The present disclosure may be embodied in other equivalent forms without departing from the scope of the present disclosure. The scope of the present disclosure is defined in the appended claims.

What is claimed is:

1. A lens, comprising:
an optically anisotropic film having an optic axis configured with an in-plane rotation in at least two opposite in-plane directions from a lens pattern center to opposite lens peripheries,
wherein the optic axis rotates in a same rotation direction from the lens pattern center to the opposite lens peripheries,
wherein an azimuthal angle changing rate of the optic axis is configured to increase from the lens pattern center to the opposite lens peripheries in at least a portion of the lens including the lens pattern center, and
wherein the lens pattern center is shifted from a geometry center of the lens by a predetermined distance in a predetermined direction.

2. The lens of claim 1, wherein the portion of the lens including the lens pattern center is substantially the entire lens.

3. The lens of claim 1, wherein the portion of the lens including the lens pattern center is a portion less than the entire lens.

4. The lens of claim 1, wherein the lens is polarization selective and is switchable between a focusing state and a defocusing state via a polarization switch coupled to the lens.

5. The lens of claim 1, wherein a phase shift experienced by a light with a wavelength λ incident onto the lens in at least the portion of the lens including the lens pattern center is
$$Γ \approx \frac{π {r}^{2}}{L λ} - \frac{2 π}{λ} K * x ,$$
where K is a non-zero coefficient, r is a distance from the lens pattern center to a local point of the lens, L is a distance between a lens plane and a focal plane of the lens, and x is a coordinate in the predetermined direction of the predetermined shift of the lens pattern center with respect to the geometry center.

6. The lens of claim 1, wherein the optically anisotropic film includes at least one of active liquid crystals, reactive mesogens, a liquid crystal polymer, or an amorphous polymer.

7. The lens of claim 1, wherein the at least two opposite in-plane directions are radial directions passing the lens pattern center of the lens.

8. The lens of claim 1, wherein the at least two opposite in-plane directions are lateral directions passing the lens pattern center of the lens.

9. The lens of claim 1, wherein the lens pattern center is a point at which the azimuthal angle changing rate of the optic axis of the optically anisotropic film is the smallest in at least the portion of the lens including the lens pattern center.

10. The lens of claim 1, wherein the lens is an off-axis focusing Pancharatnam-Berry phase (“PBP”) lens, and the lens pattern center of the off-axis focusing PBP lens is a symmetry center of a lens pattern of a corresponding on-axis focusing PBP lens.

11. A system, comprising:
an optical combiner; and
a display assembly including:
a light source configured to emit a light;
a lens configured to deflect the light, the lens including:
an optically anisotropic film having an optic axis configured with an in-plane rotation in at least two opposite in-plane directions from a lens pattern center to opposite lens peripheries,
wherein the optic axis rotates in a same rotation direction from the lens pattern center to the opposite lens peripheries,
wherein an azimuthal angle changing rate of the optic axis is configured to increase from the lens pattern center to the opposite lens peripheries in at least a portion of the lens including the lens pattern center and
wherein the lens pattern center is shifted from a geometry center of the lens by a predetermined distance in a predetermined direction; and
a beam steering device configured to steer the light received from the lens toward the optical combiner,
wherein the optical combiner is configured to direct the light received from the beam steering device to an eye-box of the system.

12. The system of claim 11, wherein a phase shift experienced by the light incident onto the lens with a wavelength λ in at least the portion of the lens including the lens pattern center is
$$Γ \approx \frac{π {r}^{2}}{L λ} - \frac{2 π}{λ} K * x ,$$
where K is a non-zero coefficient, r is a distance from the lens pattern to a local point of the lens, L is a distance between a lens plane and a focal plane of the lens, and x is a coordinate in the predetermined direction of the predetermined shift of the lens pattern center with respect to the geometry center.

13. The system of claim 11, wherein the lens is configured to convert an on-axis diverging light emitted from the light source into an off-axis collimated light.

14. The system of claim 11, wherein the optically anisotropic film includes at least one of active liquid crystals, reactive mesogens, a liquid crystal polymer, or an amorphous polymer.

15. The system of claim 11, wherein the at least two opposite in-plane directions are radial directions or lateral directions of the lens.

16. The system of claim 11, wherein the light source includes at least one of a laser diode or a vertical cavity surface emitting laser.

17. A system, comprising:
a light source configured to emit a light;
a lens configured to deflect the light to illuminate an object, the lens including:
an optically anisotropic film having an optic axis configured with an in-plane rotation in at least two opposite in-plane directions from a lens pattern center to opposite lens peripheries of the lens,
wherein the optic axis rotates in a same rotation direction from the lens pattern center to the opposite lens peripheries,
wherein an azimuthal angle changing rate of the optic axis is configured to increase from the lens pattern center to the opposite lens peripheries in at least a portion of the lens including the lens pattern center, and
wherein the lens pattern center is shifted from a geometry center of the lens by a predetermined distance in a predetermined direction;
a redirecting element configured to redirect the light reflected by the object; and
an optical sensor configured to generate an image of the object based the redirected light received from the redirecting element.

18. The system of claim 17, wherein a phase shift experienced by the light incident onto the lens with a wavelength λ in at least the portion of the lens including the lens pattern center is
$$Γ \approx \frac{π {r}^{2}}{L λ} - \frac{2 π}{λ} K * x ,$$
where K is a non-zero coefficient, r is a distance from the lens pattern center to a local point of the lens, L is a distance between a lens plane and a focal plane of the lens, and x is a coordinate in the predetermined direction of the predetermined shift of the lens pattern center with respect to the geometry center.

19. The system of claim 17, wherein the optically anisotropic film includes at least one of active liquid crystals, reactive mesogens, a liquid crystal polymer, or an amorphous polymer.

20. The system of claim 17, wherein
the lens is configured to expand the light emitted from the light source to substantially uniformly illuminate the object, and
the redirecting element includes a grating configured to diffract the light reflected by the object toward the optical sensor.
